(19) United States
(12) Patent Application Publication
(10) Pub. No.: US 2026/0355856 A1
(43) Pub. Date: Nov. 12, 2026

(54) APPARATUS AND METHOD FOR IN-SITU OPTICAL INSPECTION OF LASER-INDUCED SURFACE MODIFICATIONS AND LASER PROCESS CONTROL

(71) Applicants: Iraj Kavosh, San Jose, CA (US); Raya Kavosh, San Jose, CA (US); Roxanne Kavosh, San Jose, CA (US); Rojan Kavosh, San Jose, CA (US)

(72) Inventors: Iraj Kavosh, San Jose, CA (US); Raya Kavosh, San Jose, CA (US); Roxanne Kavosh, San Jose, CA (US); Rojan Kavosh, San Jose, CA (US)

(21) Appl. No.: 19/749,515

(22) Filed: Jul. 21, 2026

Related U.S. Application Data
(63) Continuation-in-part of application No. 18/395,601, filed on Dec. 24, 2023, now Pat. No. 12,687,491.
Application No. 18/395,601 is a continuation-in-part of application No. 17/189,221, filed on Mar. 1, 2021, now Pat. No. 11,860,091.
(60) Provisional application No. 62/956,241, filed on Jan. 1, 2020.

(51) Int. Cl. B23K 26/03; B23K 26/064; G02B 26/10

(52) U.S. Cl. CPC B23K 26/032; B23K 26/064; B23K 26/0643; G02B 26/105

(57) ABSTRACT

The present invention is an in-situ optical inspection device with closed-loop control of laser-induced modification of a workpiece. A process-laser system generates a process beam for modifying an irradiated region. An optical surface inspection system includes a probe source, an optical reflector component having a pass-through opening and surrounding reflective surface, and a probe photodetector. A beam combiner directs the process beam and a probe beam along at least part of a common optical path. A control optics assembly focuses the beams at the irradiated region and collects returned or emitted light. The probe beam passes through the opening, while the reflective surface redirects part of the returned or emitted light toward the probe photodetector. An apparatus control unit analyzes a probe detector signal and controls an operating parameter of the process-laser system based on the signal, thereby providing adaptive laser processing and optical inspection at a common workpiece region.

### BACKGROUND OF THE INVENTION

Laser-based surface modification may be used for cleaning, coating removal, texturing, patterning, drilling, grooving, cutting, remelting, smoothing, polymerization, heat treatment, and other processes in which optical energy changes a surface or removes material from it. Reliable processing depends on accurately positioning and focusing on a process beam, maintaining an appropriate angle of incidence, and delivering a controlled amount of energy to each region. These requirements become more difficult when the workpiece has curved, non-planar, hollow, or thin-walled regions, or when a feature becomes deeper during layer-by-layer ablation. In-situ optical inspection can provide useful feedback from reflected, scattered, transmitted, polarized, or emitted light, but the optical measurements must be coordinated with beam delivery, detector timing, workpiece position, and process control. Accordingly, a need exists for an integrated apparatus and method that perform laser-induced surface modification while evaluating the condition of the irradiated region and using the resulting measurements to control continued processing.

### SUMMARY OF THE INVENTION

The terminology used in this disclosure is intended to describe representative embodiments and should not be construed as limiting the scope of the invention. References to “one embodiment,” “an embodiment,” “some embodiments,” or similar phrases do not require that all disclosed features be present in a single embodiment, and features described in connection with one embodiment may be combined with features of another embodiment when technically compatible. Terms such as “comprising,” “including,” “having,” and variations thereof are intended to be open-ended, while singular terms may include plural implementations and plural terms may include singular implementations unless the context clearly requires otherwise. Relative terms such as “substantially,” “approximately,” “generally,” “near,” “adjacent,” “aligned,” “collinear,” “overlapping,” and “within a selected range” permit ordinary manufacturing, alignment, optical, control, and measurement tolerances. Likewise, references to a particular component, material, wavelength, optical arrangement, detector, positioning axis, process sequence, or application are illustrative and do not exclude technically compatible alternatives, equivalents, substitutions, rearrangements, or combinations. No embodiment, example, figure, phrase, or stated objective should be interpreted as limiting the invention to the particular structure, sequence, or use expressly described unless such limitation is expressly required by the claims.

The disclosed apparatus and methods integrate laser processing, optical surface inspection, relative positioning, signal analysis, and closed-loop process control. A process beam is directed toward an irradiated region of a workpiece to modify at least one optical, mechanical, physical, chemical, or structural property of the region. A probe beam may be directed toward the same region before, during, or after processing to characterize the condition of the region. The process beam and probe beam may share at least part of a common optical path and may be focused on substantially superimposed, partially overlapping, adjacent, or intentionally separated focal spots. Focusing optics used to deliver the outgoing beams may also collect light reflected from, transmitted through, or emitted by the irradiated region.

The collected optical information may include diffusely scattered or specularly reflected probe light, back-reflected process-laser light, transmitted light, fluorescence, polarization-dependent light, and light emitted by a laser-material interaction, including one or more selected spectral lines of a laser-induced plasma plume. Separate detector channels may isolate selected wavelength, polarization, angular, spatial, or temporal components of the collected light. The detector signals may be sampled before, during, or after a process pulse and may be analyzed individually or in combination to determine surface condition, material-removal status, delivered fluence, optical coupling, process endpoint, wall breakthrough, feature geometry, or another condition associated with the laser-induced modification.

An apparatus control unit may associate detector measurements with workpiece position, workpiece orientation, pulse timing, process parameters, and processing history. Based on the detector measurements, the apparatus control unit may continue processing, re-irradiate a region, omit or terminate irradiation, or adjust one or more operating parameters, including pulse energy, pulse duration, pulse count, repetition rate, scan speed, beam overlap, focal position, focal-spot geometry, workpiece position, workpiece angle, layer increment, assist-gas flow, or extraction operation. Measurements obtained from successive regions may be stored as a one-dimensional profile, two-dimensional image, three-dimensional map, or other spatially indexed data structure representing the processed or inspected workpiece.

Relative positioning may be provided by translating or rotating the workpiece, moving a control optics assembly, scanning one or more beams, or coordinating multiple positioning mechanisms. The positioning system may maintain a desired focal position and angle of incidence as successive regions of a planar, curved, faceted, free-form, or otherwise non-planar workpiece are processed. The disclosed arrangements may be used with solid workpieces, hollow or thin-walled objects, membranes, coatings, tubes, shells, balloons, semiconductor slabs, diamond slabs, and other rigid or compliant articles. A transmitted-light detector may be positioned behind, beneath, or within a thin wall, while returned-light, polarization-sensitive, and plasma-emission detectors may provide additional diagnostic information.

For ablation, grooving, micro-drilling, patterning, and cutting, material may be removed region by region and layer by layer. A multi-axis positioning arrangement may vary the relative angle between the process beam and the workpiece as a groove or cutting kerf deepens to improve optical access, laser-energy coupling, kerf-width uniformity, sidewall straightness, kerf-width reduction, and kerf-wall quality. The apparatus may form shallow or deep grooves, craters, blind holes, through-holes, patterned regions, cutting paths, and separated workpiece portions. Representative applications include laser cleaning, coating removal, surface texturing, surface remelting, smoothing, polymerization, medical-balloon micro-drilling, semiconductor processing, and cutting of silicon, silicon-carbide, or diamond slabs into thinner articles.

An assist-gas assembly may direct a pressurized gas stream toward the processing region to remove molten material, particles, vapor, plasma, and other debris; reduce redeposition, oxidation, or burning; and protect beam-delivery optics. An extraction system may evacuate particles, contaminants, paint dust, process gases, and other by-products. The disclosed processing operations may begin directly on a smooth or rough starting surface without requiring a separate preliminary surface-conditioning pass, although optional cleaning, alignment, or calibration operations may be performed when desired.

### BRIEF DESCRIPTION OF THE FIGURES

FIG. 1 illustrates a beam-scanning system including a rotating polygon mirror and a galvanometer mirror.

FIG. 2 illustrates an integrated laser-processing and optical-inspection apparatus for processing planar and non-planar workpieces.

FIG. 3 illustrates the apparatus processing and inspecting a hollow or thin-walled workpiece using transmitted-light detection.

FIG. 4 illustrates a process-laser return detection arrangement associated with the control optics assembly.

FIG. 5 illustrates a multi-signal detection arrangement for measuring probe return, process return, and plasma emission.

FIG. 6A illustrates an XYZ positioning system for forming an ablated feature in a workpiece.

FIG. 6B illustrates a wavelength-selective return-light arrangement having a beam blocker and detector aperture.

FIG. 6C illustrates an annular return-light separation component having a central pass-through opening.

FIG. 7 illustrates a four-axis positioning system for layer-by-layer grooving or cutting of a workpiece.

FIG. 8A illustrates the workpiece in a neutral angular position during removal of material from a cutting kerf.

FIG. 8B illustrates the workpiece in a first angular position for processing adjacent to one kerf sidewall.

FIG. 8C illustrates the workpiece in a second angular position for processing adjacent to an opposite kerf sidewall.

FIG. 9 illustrates an alternative optical architecture having returned-light detector channels located primarily within the optical surface inspection system.

FIG. 10A illustrates representative timing for sampling back-reflected process-laser light during a process-laser pulse.

FIG. 10B illustrates representative timing for sampling back-reflected probe light before and during a process-laser pulse.

FIG. 10C illustrates representative timing for sampling a selected plasma-emission spectral line after a process-laser pulse.

### DETAILED DESCRIPTION OF THE INVENTION

The disclosed system uses a laser to perform work on a selected part of an object and uses optical measurements to determine what occurred at that location. The laser may clean, heat, smooth, drill, groove, cut, pattern, or otherwise modify the object. Rather than assuming that every laser pulse produces the intended result, the system observes light associated with the treated region and uses that information to determine whether processing should continue or be changed.

The optical inspection may be obtained by directing a separate probe beam toward the workpiece, by measuring a portion of the process beam reflected from the workpiece, by measuring light transmitted through a thin wall, or by measuring light emitted when the laser interacts with the material. The system may use one of these measurements or combine several measurements. Optical filters, reflectors, apertures, polarizers, and detector channels help separate the useful signal from unwanted light.

A controller coordinates the laser, optical detectors, and positioning mechanisms. The workpiece or optical assembly can move in several linear and rotational directions so that the laser remains focused on curved and irregular surfaces and approaches each region at an appropriate angle. Detector measurements are linked to the corresponding workpiece location, allowing the controller to reprocess an incomplete region, reduce energy at an overtreated region, or change conditions for a later region or layer.

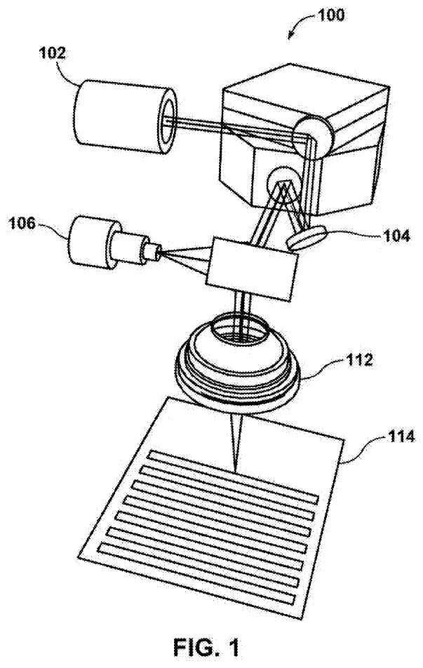

FIG. 1 illustrates one embodiment of a beam-positioning arrangement that rapidly moves a laser beam over a target surface. A rotating polygon mirror scans the beam in one direction, a galvanometer mirror scans the beam in a transverse direction, and an F-theta lens focuses the scanned beam on successive surface regions. The later figures build on this beam-delivery foundation by adding the optical inspection channels, multi-axis workpiece positioning, process monitoring, and feedback control used for more complex workpieces and laser processes.

FIG. 1 illustrates an exemplary beam-scanning system 100 having a rotating polygon mirror according to one or more embodiments. The beam-scanning system 100 includes a laser 102, an X-scanning polygon mirror 104, a Y-scanning galvanometer mirror 106, and an F-theta lens 112 arranged to direct and scan a laser beam across a target surface 114. The X-scanning polygon mirror 104 scans the laser beam primarily along a first scan direction, and the Y-scanning galvanometer mirror 106 scans the laser beam primarily along a second scan direction transverse to the first scan direction.

The laser 102 generates and directs the laser beam toward the X-scanning polygon mirror 104. The laser 102 may comprise a pulsed laser, a continuous-wave laser, a modulated laser, or another optical source suitable for processing or inspecting the target surface 114. In a laser-processing embodiment, the wavelength, pulse energy, pulse duration, repetition rate, and focal-spot characteristics of the laser 102 may be selected so that material of the target surface 114 absorbs sufficient optical energy to produce an intended surface modification.

The X-scanning polygon mirror 104 may include a rotatable polygon having a plurality of reflective facets. Rotation of the polygon successively positions the reflective facets in the path of the laser beam and changes the angular direction of the laser beam. The changing angular direction produced by the rotating facets scans the laser beam along the first scan direction across the target surface 114.

The rotational speed of the X-scanning polygon mirror 104, the number and angular arrangement of its reflective facets, and the timing of the laser 102 may be selected according to a desired scan rate, scan-line length, spacing between irradiated regions, pulse overlap, and processing or inspection resolution. The laser 102 may be enabled only while a selected reflective facet directs the laser beam through a useful portion of the optical scan field.

The Y-scanning galvanometer mirror 106 may include a reflective mirror coupled to a galvanometer actuator that controllably changes the angular orientation of the reflective mirror. The Y-scanning galvanometer mirror 106 receives the laser beam from the X-scanning polygon mirror 104 and redirects the laser beam toward the F-theta lens 112. Angular movement of the Y-scanning galvanometer mirror 106 scans the laser beam along the second scan direction.

Coordinated operation of the X-scanning polygon mirror 104 and the Y-scanning galvanometer mirror 106 positions the laser beam at successive two-dimensional locations on the target surface 114. The X-scanning polygon mirror 104 may provide relatively rapid scanning along individual scan lines, while the Y-scanning galvanometer mirror 106 incrementally or continuously changes the location of successive scan lines.

The F-theta lens 112 receives the angularly scanned laser beam from the Y-scanning galvanometer mirror 106 and focuses the laser beam at successive irradiated regions of the target surface 114. The F-theta lens 112 may be selected according to the wavelength of the laser beam, a desired working distance, dimensions of the scan field, and a desired focal-spot size, focal-spot shape, or focal-spot intensity profile.

In one embodiment, the F-theta lens 112 provides a predetermined relationship between angular deflection of the incoming laser beam and lateral position of the focused laser beam on the target surface 114. The F-theta lens 112 may maintain the focused laser beam within a substantially common focal plane across at least a selected portion of the scan field. Other focusing optics may be used where a different focal-plane geometry or scan-field relationship is desired.

Coordinated scanning by the X-scanning polygon mirror 104 and the Y-scanning galvanometer mirror 106 may produce a raster pattern, a plurality of substantially parallel scan lines, a vector pattern, a contour-following pattern, or another selected arrangement of irradiated regions on the target surface 114. Adjacent irradiated regions may overlap, abut, or remain separated according to the intended processing or inspection operation.

The laser 102 may be triggered, pulsed, or modulated according to an instantaneous angular position of the X-scanning polygon mirror 104 and the Y-scanning galvanometer mirror 106. A controller may receive position, velocity, index, synchronization, encoder, or trigger information from one or both scanning devices and may cause the laser 102 to emit one or more pulses when the focused laser beam is positioned at a selected region of the target surface 114. Each emitted pulse may thereby be associated with a defined surface position.

The beam-scanning system 100 may deliver the laser beam as a process beam configured to modify an optical, mechanical, physical, or chemical property of an irradiated region of the target surface 114. Representative surface modifications include cleaning, coating removal, texturing, patterning, structuring, heating, remelting, smoothing, polymerization, drilling, grooving, ablation, and cutting.

The surface modification produced at a particular region may depend on the wavelength, pulse energy, pulse duration, repetition rate, focal-spot dimensions, focal-spot intensity distribution, scan speed, pulse spacing, region overlap, angle of incidence, and material properties of the target surface 114. One or more of those parameters may be selected or adjusted to achieve a predetermined modification while limiting undesired thermal or mechanical effects.

The beam-scanning system 100 may additionally or alternatively deliver the laser beam as a probe illumination beam used to inspect the target surface 114. In one embodiment, the laser beam functions as a process beam during a processing interval and as a probe beam during an inspection interval. In another embodiment, a separate process beam and probe beam are combined upstream of the X-scanning polygon mirror 104 so that both beams are directed through the X-scanning polygon mirror 104, the Y-scanning galvanometer mirror 106, and the F-theta lens 112 toward a common, overlapping, or closely spaced region of the target surface 114.

When the beam-scanning system 100 is incorporated into an in-situ processing and inspection apparatus, optical measurements may be temporally synchronized with operation of the laser 102. A probe measurement may be obtained before delivery of a process pulse to characterize a region before processing. A further probe measurement may be obtained after completion of the process pulse, or after completion of a selected plurality of process pulses, to characterize the resulting surface modification.

Returned optical energy may include back-scattered probe light, specularly reflected probe light, back-reflected process-laser light, fluorescence, or light emitted by an interaction between the laser beam and material of the target surface 114. An optical surface inspection assembly, optical reflector component, photodetector subassembly, and signal analyzer may collect and measure one or more such optical signals. Those components are omitted from FIG. 1 for clarity and are described in connection with subsequent figures.

Sampling, measuring, and analyzing returned light from a processed region may be temporally synchronized with one or more process-laser pulses. In one embodiment, returned probe light or fluorescence is measured after completion of a process pulse or a selected plurality of process pulses to provide in-situ post-process inspection of the region. The resulting measurement may indicate whether an intended surface modification was achieved.

A control unit may compare a measured optical signal from an irradiated region with a predetermined value, acceptable range, preceding measurement, or expected result. When the measured signal indicates that the intended modification was not achieved, the control unit may adjust the energy, duration, repetition rate, or number of subsequent laser pulses; change scan speed or overlap; re-irradiate the region; or modify processing of a later region.

Position information associated with the X-scanning polygon mirror 104 and the Y-scanning galvanometer mirror 106 may be used to correlate each emitted process pulse and each optical measurement with a corresponding region of the target surface 114. Measurements obtained from successive regions may be assembled into a one-dimensional profile, two-dimensional image, or three-dimensional map representing the processed or inspected surface.

The beam-scanning system 100 may operate independently or in combination with a positioning stage that translates or rotates the target surface 114. Beam scanning may provide rapid local positioning within an optical scan field, while stage motion may move a larger workpiece between scan fields or change the orientation of a non-planar surface relative to the laser beam.

The X-scanning polygon mirror 104 and the Y-scanning galvanometer mirror 106 may be used with other scanning or positioning arrangements. For example, a polygon mirror may be combined with a linear translation stage, a galvanometer scanner may be combined with workpiece rotation, or beam scanning may be coordinated with a multi-axis positioning system to maintain focal position and angle of incidence over a curved or otherwise non-planar workpiece.

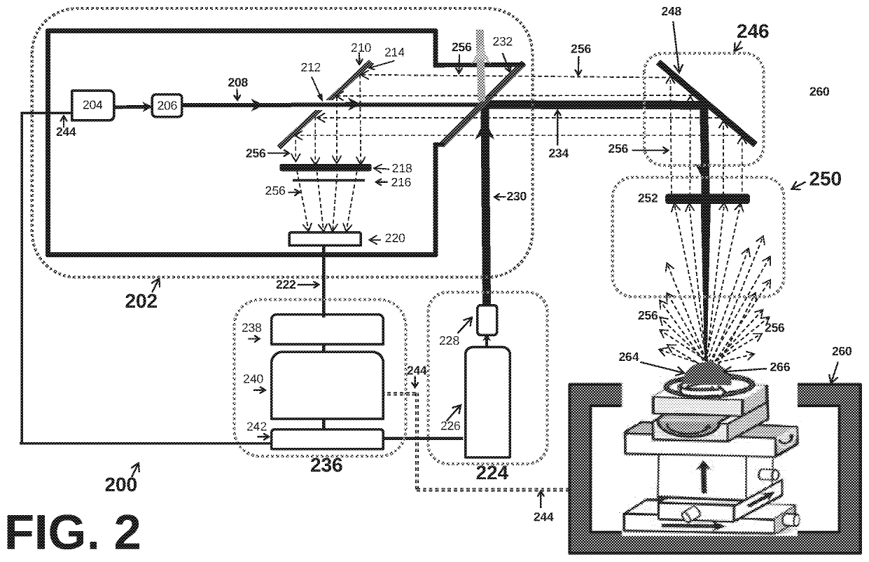

Referring to FIG. 2, an integrated laser-processing and optical-inspection apparatus 200 is configured to modify and inspect planar and non-planar workpieces while coordinating optical delivery, returned-light collection, detector sampling, and relative positioning of the workpiece and optical components. The apparatus 200 may perform laser surface modification and in-situ optical inspection region by region over a three-dimensional workpiece surface.

The apparatus 200 includes an optical surface inspection (OSI) system 202. The OSI system 202 includes a probe source 204 and probe-source beam-adjusting optics 206 configured to generate and condition a probe beam 208. The probe source 204 may comprise a laser or another illumination source having a wavelength, bandwidth, coherence, polarization, and output power selected for the intended optical measurement. The probe beam 208 may be pulsed, continuous-wave, or modulated independently of a process beam.

The probe-source beam-adjusting optics 206 may collimate, expand, reduce, spatially filter, polarize, attenuate, or steer the probe beam 208. The probe-source beam-adjusting optics 206 may include refractive optics, reflective optics, diffractive optics, apertures, beam expanders, cylindrical lenses, polarizers, wave plates, or combinations thereof. The optics may be selected to produce a desired probe-beam diameter, divergence, spatial profile, and polarization before the probe beam enters a common optical path.

The probe beam 208 passes through an optical reflector component 210 having a pass-through opening 212 and a reflective surface 214 surrounding at least part of the pass-through opening 212. The outgoing probe beam 208 preferably has a beam diameter or spatial extent that permits most of the outgoing beam to pass through the pass-through opening 212 without being intercepted by the reflective surface 214.

Returned light generally has a broader angular or spatial distribution than the outgoing probe beam 208. The reflective surface 214 intercepts at least a portion of that returned light and redirects the intercepted portion toward a probe detector channel. Specularly returned light that remains closely aligned with the outgoing probe path may pass through the pass-through opening 212, thereby reducing the amount of a strong specular component that reaches the probe detector channel.

The redirected light passes through a probe optical filter 216 and a probe-light condensing lens 218 to a probe photodetector 220. The probe optical filter 216 may transmit a selected probe wavelength or wavelength band while attenuating process-laser radiation, plasma emission, ambient illumination, or another undesired component. The filter may additionally or alternatively select a polarization state.

The probe-light condensing lens 218 concentrates selected optical energy onto an active area of the probe photodetector 220. The probe photodetector 220 may comprise a silicon photodiode or another detector having a spectral response and temporal response suitable for the selected wavelength and sampling interval. The probe photodetector 220 produces a probe detector signal 222.

The apparatus further includes a process-laser system 224 having a process-laser source 226 and process-beam-adjusting optics 228 configured to generate and condition a process beam 230. The process-laser source 226 may comprise a pulsed laser selected for ablation, cleaning, coating removal, texturing, patterning, drilling, grooving, cutting, remelting, smoothing, polymerization, heat treatment, or another laser-induced modification. A continuous-wave or modulated source may be used for processes that do not require discrete pulses.

The process-beam-adjusting optics 228 may control beam diameter, divergence, polarization, pulse energy, spatial intensity profile, and alignment before the process beam 230 reaches a beam combiner. The process-beam-adjusting optics 228 may include one or more attenuators, beam expanders, apertures, cylindrical lenses, refractive or diffractive beam-shaping elements, polarization elements, or steering optics.

A beam combiner 232 combines the process beam 230 and probe beam 208 to form a combined process-and-probe beam 234 along at least a portion of a common optical path. In one embodiment, the beam combiner 232 is primarily reflective at the process wavelength and transmissive at the probe wavelength. In another embodiment, the reflection and transmission relationships are reversed. Partial transmission at the process wavelength may be permitted when a process-return measurement is desired.

The process beam 230 and probe beam 208 may have the same wavelength or different wavelengths and may have the same or different polarization states, or one or both beams may have randomly polarized light. The beams may be substantially collinear along the common optical path. As used here, substantially collinear permits a small angular or lateral offset consistent with focusing the beams at substantially the same or intentionally separated positions on a workpiece surface.

The apparatus includes an apparatus control unit 236 having a signal analyzer 238, control electronics 240, and control software 242. The apparatus control unit 236 may additionally include one or more processors, memories, signal conditioners, digitizers, timing circuits, motion controllers, and stored program instructions.

The signal analyzer 238 may determine an absolute or normalized intensity, a difference or ratio between detector measurements, a temporal change, a polarization change, an integrated signal, a threshold crossing, a selected spectral-line intensity, or another parameter derived from a detector signal. Detector measurements may be normalized using a source-monitor measurement, calibration value, reference region, or preceding measurement.

The control electronics 240 may generate laser triggers, detector-gating signals, scanner commands, stage commands, synchronization signals, and safety interlocks. The control software 242 may associate each detector measurement with a corresponding position and orientation of the workpiece and may implement a stored processing recipe, inspection sequence, or closed-loop control algorithm.

A control and data link 244 couples the apparatus control unit 236 to the optical sources, detectors, positioning system, and other controlled components. The control and data link 244 may include wired, optical, or wireless communication paths and may carry command, status, timing, position, detector, calibration, and process data.

The apparatus further includes turning optics 246 having at least one turning mirror 248 arranged to direct the combined process-and-probe beam 234 toward a control optics assembly. The turning optics 246 may include additional mirrors or beam-routing components when required by the mechanical arrangement of the apparatus. The turning mirror 248 may be highly reflective over the process and probe wavelengths and over one or more wavelengths selected for returned-light collection.

A control optics assembly (COA) 250 includes focusing optics 252 configured to focus the process beam 230 and probe beam 208 at a focal region. The focusing optics 252 may comprise a telecentric lens, an F-theta lens, a simple focusing lens, an achromatic lens group, reflective focusing optics, or another arrangement selected for the working distance, numerical aperture, scan field, and process and probe wavelengths.

The focusing optics 252 also collects at least a portion of returned and/or emitted light 256 from the focal region. The collected light may include diffuse or back-scattered probe light, specularly reflected probe light, back-reflected process light, fluorescence, polarization-dependent light, light emitted by a laser-material interaction, and light emitted by a laser-induced plasma plume.

At least part of the returned and/or emitted light 256 travels through a bidirectional common optical path that is also used to deliver the process beam 230 and probe beam 208. The common path need not be identical for every constituent wavelength over its entire length. Dichroic, partially reflective, polarization-selective, apertured, or wavelength-separating components may establish shared and separated portions of the outgoing and return paths.

The apparatus control unit 236 supplies a positioning control signal through the control and data link 244 to coordinate relative motion with operation of the process-laser source 226 and sampling of detector signals. A multi-axis positioning system 260 supports a workpiece mount carrying a solid workpiece 264 having a planar, curved, faceted, free-form, or otherwise non-planar workpiece surface 266. The workpiece mount may comprise a chuck, clamp, vacuum fixture, magnetic fixture, nest, carrier, conformable support, or another mounting mechanism suitable for the workpiece geometry and material. The mount may expose the region to be processed while limiting unwanted deformation, slippage, or vibration.

In an illustrated six-axis embodiment, the multi-axis positioning system 260 includes a linear stage assembly and a rotational stage assembly. The linear stage assembly provides X, Y, and Z translation, and the rotational stage assembly provides pitch, roll, and yaw rotation. Motion may be continuous, incremental, point-to-point, scanned, or coordinated among multiple axes.

The focusing optics 252 produces a process focal spot and a probe focal spot at or near an irradiated surface region. The process focal spot and probe focal spot may be substantially superimposed, partially overlapping, adjacent, or separated by a selected distance. The multi-axis positioning system 260 may translate and rotate the solid workpiece 264 so that successive irradiated surface regions are brought to the focal region while an angle of incidence remains within a selected range.

When the focal spots are spatially separated, the probe focal spot may lead the process focal spot along a processing direction for pre-process inspection or trail the process focal spot for post-process inspection. A selected spatial offset may be produced by a wedge prism or another beam-separation optic positioned in the common optical path. The two focal spots may move concurrently over the workpiece surface 266 while maintaining the selected lead, lag, overlap, or gap.

The process focal spot and probe focal spot may have flat-top, Gaussian, super-Gaussian, multimode, Bessel, Airy, annular, or combined intensity profiles. A focal spot may be circular, semicircular, elliptical, square, rectangular, elongated, or line-shaped. A line-shaped focal spot may have a substantially uniform intensity along the line and a Gaussian distribution transverse to the line, or a substantially uniform distribution along both axes.

Beam shaping may be performed using refractive optics, diffractive optics, cylindrical lenses having different focal lengths, apertures, homogenizers, or combinations thereof. Selection of a focal-spot geometry may depend on the desired modification. An elongated line may improve throughput for a strip-like process region, while a compact circular or square spot may be selected for drilling, localized ablation, or high-resolution patterning.

The selected angle of incidence may be substantially normal to a local surface normal, may be maintained at a fixed non-normal value, or may vary according to material, desired modification, collection geometry, polarization condition, or avoidance of a strong specular return. The motion trajectory may be based on a stored surface model, a taught path, encoder coordinates, a scan plan, optical feedback, or a combination thereof.

The control software 242 may store detector data as a one-dimensional profile, a two-dimensional image, or a three-dimensional map. Each pixel or data record may correspond to a defined workpiece region and may include a measured optical value, process parameters, position, orientation, time, pulse number, layer number, and an indication of whether the intended modification was achieved.

Based on detector data, the apparatus control unit 236 may allow processing to continue, change pulse energy or duration, change repetition rate or pulse count, change scan speed or overlap, adjust focal position, adjust relative angle, omit a pulse, re-irradiate a region, identify a region for later rework, or stop the process. A measurement from one region may control additional processing of that region, processing of a later region, or processing of a later layer.

In another embodiment, the positioning system provides five-axis positioning including X, Y, and Z translation and theta and phi rotation. In another embodiment, X-Y beam scanning is combined with Z, theta, and phi workpiece positioning. A further alternative uses beam scanning for X-Y positioning together with a four-axis workpiece stage providing Z, yaw, pitch, and roll adjustment. In another arrangement, the COA 250 is mounted to an XYZ stage while the workpiece is mounted to a three-axis rotational stage, thereby providing a combined six-axis relative positioning arrangement. A multi-axis stage associated with the COA may also be coordinated with a separate multi-axis workpiece stage.

The beam-scanning system 100 described in connection with FIG. 1 may be incorporated into the apparatus 200 to provide rapid X-Y beam positioning while the multi-axis positioning system 260 provides larger-scale translation, focus adjustment, or workpiece orientation. Other implementations may use galvanometer mirrors, a rotating polygon mirror, a combination of polygon and galvanometer scanning, or a linear translation combined with a rotating polygon mirror.

For a large workpiece, the COA 250 may be mounted to a robotic manipulator, gantry, articulated arm, or mobile platform while the workpiece remains substantially stationary. The process beam 230 and probe beam 208 may be transported from stationary source assemblies to the movable COA 250 through one or more optical fibers or other beam-delivery media. Translational and rotational axes associated with the movable COA may maintain focal position and angle of incidence over a large, curved structure.

One or both of the process beam 230 and probe beam 208 may be polarized. A polarizer, analyzer, wave plate, polarization beam splitter, or polarization-sensitive detector may be used to measure a polarization state or a change in polarization caused by a surface modification. Polarization measurements may be used alone or in combination with intensity, spectral, temporal, or transmitted-light measurements.

The solid workpiece 264 may have convex, concave, cylindrical, spherical, faceted, free-form, planar, and non-planar portions. The workpiece may comprise polymer, a polymer coating, semiconductor material, a semiconductor coating, silicon, silicon carbide, diamond, glass, ceramic, metal, composite material, or another material compatible with the selected laser process. The workpiece may be rigid or locally compliant.

The apparatus 200 may perform laser ironing or remelting of a surface layer, smoothing of an additively manufactured polymer surface, polymerization of a surface material or coating, cleaning, rust removal, stain removal, paint or coating removal, texturing, structuring, patterning, heat treatment, drilling, grooving, cutting, or another modification. Detector measurements may distinguish an untreated region, a partially modified region, an acceptably modified region, and an overtreated region.

In a marine or structural-cleaning embodiment, a robotic or mobile implementation of the COA 250 follows a large non-planar workpiece. Optical feedback may distinguish removal of rust, paint, stain, or another coating from exposure of an underlying substrate, thereby reducing the likelihood of damaging the substrate while improving coverage and repeatability.

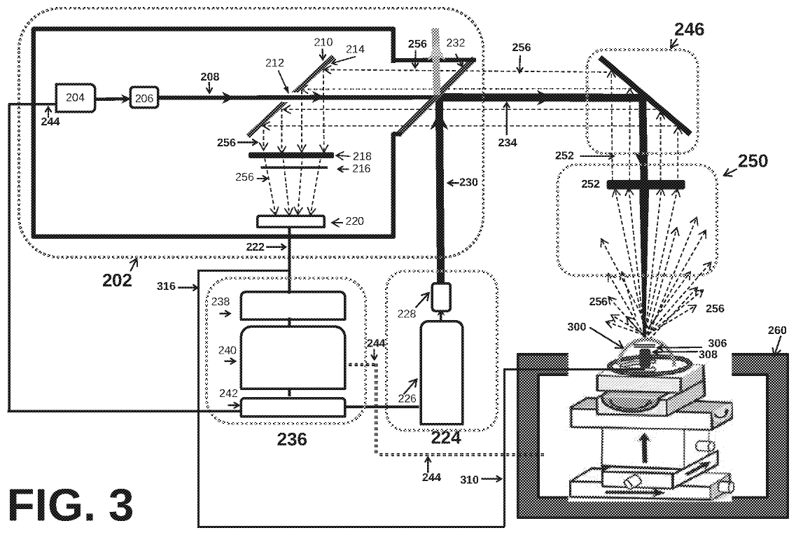

Referring to FIG. 3, the integrated apparatus 200 processes and inspects a hollow or thin-walled workpiece 300 having an outer wall and an interior cavity. The outer wall may define a closed or partially closed enclosure and may include planar, curved, cylindrical, balloon-shaped, free-form, or combined surface regions.

The hollow or thin-walled workpiece 300 may comprise a rigid material, compliant material, polymer, polymer coating, medical balloon, catheter balloon, tube, shell, thin metal wall, ceramic wall, glass wall, semiconductor membrane, or another wall through which a useful optical signal can be measured. The embodiment may also be used with a non-planar thin plate or a locally thin portion of an otherwise solid workpiece.

A transmitted-light optical element 306 is positioned to receive light passing through the outer wall. The transmitted-light optical element 306 may comprise an optical filter, polarizer, analyzer, aperture, lens, or combination thereof selected to isolate a constituent wavelength, wavelength band, angular component, or polarization.

A transmitted-light photodetector 308 receives light from the transmitted-light optical element 306. The transmitted-light photodetector 308 may be selected according to the probe wavelength, process wavelength, emitted wavelength, expected optical power, and required temporal response.

The transmitted-light photodetector 308 supplies a transmitted-light detector signal 310 to the signal analyzer 238. The transmitted-light detector signal 310 may be sampled before, during, or after a process pulse and may be normalized to a baseline, reference measurement, source-monitor signal, or preceding measurement.

A transmitted-light detector mount supports the transmitted-light optical element 306 and transmitted-light photodetector 308 beneath, behind, or within the hollow or thin-walled workpiece 300. The transmitted-light detector mount may move with the workpiece, may be carried by an independently controlled stage, or may remain stationary while the workpiece is positioned relative to the detector.

Transmitted light 314 passes through the outer wall from the irradiated surface region toward the transmitted-light optical element 306 and transmitted-light photodetector 308. The transmitted light 314 may comprise probe light, process light, light emitted by laser-material interaction, or a selected combination thereof.

A detector positioning control signal 316 may coordinate motion of the transmitted-light detector mount with motion of the workpiece. The apparatus control unit 236 may maintain the transmitted-light photodetector 308 in a fixed or predetermined relationship with the focal region by moving the detector with the workpiece, by coordinating separate stages, or by using a detector field of view that encompasses a selected range of workpiece positions.

The multi-axis positioning system 260 and workpiece mount support and orient the hollow or thin-walled workpiece 300. The workpiece mount may grip a neck, flange, edge, carrier, internal support, or another portion of the workpiece while maintaining optical access to the irradiated surface region and to a side of the outer wall opposite the incident process beam 230 and probe beam 208.

The positioning system may move the hollow or thin-walled workpiece 300 region by region under substantially stationary process and probe beams. Translational and rotational motion may maintain the process focal spot and probe focal spot on the outer wall and may maintain the angle of incidence and detector alignment across curved portions of the workpiece.

A transmitted-light measurement may indicate wall thickness, absorption, melting, remelting, polymerization, coating condition, hole initiation, or breakthrough. During micro-drilling, an increase, decrease, or temporal change in transmitted light 314 may indicate completion of a through-hole. During remelting or smoothing, a change in transmitted intensity or polarization may indicate a change in wall or coating condition.

The probe photodetector 220 may measure returned probe light while the transmitted-light photodetector 308 measures transmitted light 314. The apparatus control unit 236 may compare or combine the two measurements to distinguish a change in surface reflectivity from a change in transmission. Process control may be based on either signal individually, a difference or ratio between the signals, or another combined analysis.

In a medical application, the hollow or thin-walled workpiece 300 may be an intravenous drug-delivery balloon or catheter balloon. The apparatus may position successive locations along the curved balloon wall and form laser-drilled micro-holes while monitoring transmitted light, probe return, process return, and plasma emission to verify processing and reduce damage to surrounding wall material.

In a polymer-processing embodiment, the process beam 230 operates below, near, or above a selected modification threshold to remelt, iron, smooth, or polymerize the outer wall or a coating on the outer wall. The multi-axis positioning system 260 maintains focal position and angle of incidence while transmitted-light and returned-light measurements are used to limit overheating, thinning, or unintended perforation.

The hollow-workpiece embodiment may also be used to process a thin-walled rigid shell, a compliant membrane, a non-planar thin plate, or a locally thinned region. The transmitted-light detector may be positioned on a stationary support, within a cavity, beneath a transparent carrier, or on a stage that follows the irradiated region.

The transmitted-light optical element 306 may be selected to reject ambient light or strong process-laser radiation while transmitting a probe wavelength. Alternatively, the transmitted-light optical element 306 may select the process wavelength or a wavelength emitted by the laser-material interaction. A polarization analyzer may be used when wall stress, orientation, birefringence, or modification-induced polarization change provides a useful measurement.

The apparatus control unit 236 may determine an endpoint based on a threshold or temporal change in the transmitted-light detector signal 310. The endpoint may correspond to a completed through-hole, a selected residual wall thickness, a desired remelting condition, or another process result. Processing may stop, move to a subsequent region, or continue with modified parameters after the endpoint is detected.

The transmitted-light detector channel may be used with pre-process and post-process measurements. A baseline transmission measurement may be obtained before irradiation, and a subsequent measurement may be compared with the baseline after one pulse, multiple pulses, or a completed scan. The comparison may be stored with position and process data as part of an inspection image or map.

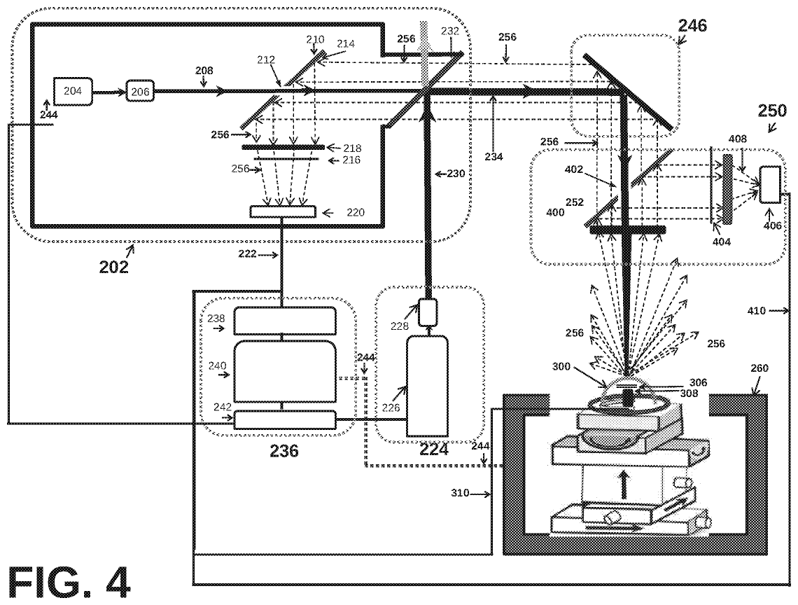

Referring to FIG. 4, the apparatus 200 includes a return-light dichroic mirror 400 within or optically associated with the COA 250. The return-light dichroic mirror 400 includes or is positioned adjacent to a return-path pass-through opening 402 through which the outgoing combined process-and-probe beam 234 travels toward the focusing optics 252.

A process-return optical filter 404 is positioned in a separated return path. The process-return optical filter 404 transmits the process-laser wavelength or a selected band containing that wavelength while attenuating probe light, plasma emission, ambient illumination, or another undesired component.

A process-return photodetector 406 receives optical energy transmitted by the process-return optical filter 404. The process-return photodetector 406 may be selected according to the process wavelength, expected return magnitude, dynamic range, and required temporal response.

The return-light dichroic mirror 400 separates a back-reflected process-light component 408 from other portions of the returned and/or emitted light 256 and redirects the back-reflected process-light component 408 through the process-return optical filter 404 to the process-return photodetector 406. In one embodiment, the return-light dichroic mirror 400 highly reflects the process-laser wavelength while substantially transmitting a desired returned probe wavelength. In another embodiment, the reflection and transmission relationships are reversed.

The process-return photodetector 406 supplies a process-return detector signal 410 to the signal analyzer 238. The process-return detector signal 410 may represent specularly reflected process light, diffusely scattered process light, or a combination thereof.

The focusing optics 252 collect returned light from the irradiated surface region and substantially collimates at least part of the collected light. Detector geometry, apertures, and optical coatings may be selected to emphasize a desired angular component or to limit detector saturation from a strong specular return.

The magnitude and temporal behavior of the process-return detector signal 410 may provide information regarding coupling of the process beam 230 into the workpiece, delivered fluence, surface condition, formation of a plasma plume, change in crater or kerf geometry, or development of a through-hole. The signal may be sampled during selected portions of a process pulse or between pulses.

A change in process return may be correlated with reaching an ablation threshold. In some materials and process conditions, reflected process intensity decreases as energy coupling and material removal increase. A later decrease may alternatively result from plasma shielding, geometric blocking by a deep feature, defocus, or another condition. The apparatus control unit 236 may therefore interpret the process-return detector signal 410 alone or together with probe return, transmitted light, plasma emission, position, and process history.

The process-return detector channel is particularly useful during micro-drilling, surface patterning, grooving, and ablation cutting, where the process-laser wavelength itself serves as a diagnostic probe of the irradiated region. The detector channel may also be used during cleaning, coating removal, remelting, or another process when process-wavelength reflectivity changes provide useful feedback.

The apparatus of FIG. 4 may retain the transmitted-light detector channel described in connection with FIG. 3. Thus, returned probe light, back-reflected process light, and transmitted light may be measured for the same irradiated region. The measurements may be temporally separated or acquired during overlapping intervals according to source and detector response.

The process-return photodetector 406 may be located within the COA 250, on a fixed support adjacent to the COA, or in an optically coupled remote detector module. Locating the detector near the focusing optics may reduce return-path length and permit efficient collection, while a remote arrangement may simplify thermal management, service, or detector replacement.

A detector gain, attenuation level, aperture, or integration time may be adjusted according to expected return intensity. A calibration measurement may be obtained from a reference surface or from an unmodified region of the workpiece. The calibrated process-return measurement may be associated with workpiece position and used to control subsequent process pulses.

The process-return detector signal 410 may be used to adjust pulse energy, pulse count, focal position, scan speed, workpiece angle, or layer increment. A sudden signal transition may be used as an endpoint or fault indicator, and an unexpected signal may cause the apparatus control unit 236 to pause processing for inspection or re-alignment.

Laser ablation includes removal of material from an irradiated region by delivery of laser energy sufficient to produce vaporization, sublimation, melting and expulsion, photochemical decomposition, spallation, or a combination of removal mechanisms. The mechanism depends on material properties, wavelength, pulse duration, focal-spot area, pulse energy, repetition rate, ambient environment, and feature geometry.

Areal energy density at an irradiated region may be expressed as laser energy delivered per unit area. Material removal generally begins when the delivered fluence reaches or exceeds an ablation threshold associated with the material and pulse conditions. The threshold may vary with surface condition, wavelength, pulse duration, pulse history, ambient gas, and heat accumulation.

In selected materials and pulse regimes, a controlled removal increment may approach one or more atomic or molecular layers. In other processes, each pulse or scan removes a substantially greater thickness. A layer-by-layer process may define a layer as material removed by a single pulse, a selected pulse group, a complete scan over a feature area, or another controlled depth increment.

Laser ablation may provide high dimensional precision while limiting a heat-affected zone, particularly when pulse duration, energy, and scan conditions are selected for the workpiece material. Representative applications include micro-drilling, micro-or nano-patterning, groove and crater formation, surface texturing, cleaning, coating removal, and precision cutting.

A laser-induced plasma plume may form during ablation and may emit continuum radiation and discrete spectral lines associated with the ablated material and plasma conditions. The useful spectral line, delay interval, and sampling duration depend on material and process. For a single-crystal diamond example, a prominent line near approximately 427 nm may be selected as a diagnostic wavelength, while other materials may use different wavelengths.

A selected plasma-emission spectral line may be measured to monitor whether ablation is occurring, to compare relative ablation intensity among regions or layers, or to identify a change in process condition. Sampling may be delayed after a process pulse to reduce interference from an early continuum-emission phase and to improve discrimination of a selected line.

Back-reflected process light may provide a separate diagnostic signal. In some conditions, a decrease in reflected process intensity accompanies transition from a sub-threshold condition to effective ablation. A decrease may also result from excessive plume shielding or geometric obstruction in a deep crater or kerf. Multiple signals may therefore be analyzed together to distinguish among possible causes.

Back-reflected probe light may be measured immediately before a process pulse to establish a pre-process condition and again near the end of the pulse or after processing to assess the resulting modification. Probe-return measurements may be compared with process return and plasma emission to improve confidence in a process decision.

No preliminary surface-conditioning pass is required before grooving, crater formation, micro-patterning, micro-drilling, or cutting. Semiconductor wafers, polymer medical balloons, and other comparatively smooth workpieces may be processed directly. A diamond or other slab having a relatively rough starting surface may likewise be cut without a separate smoothing or preparation pass.

An optional cleaning, alignment, or calibration operation may be performed when independently desired, but such an operation is not a prerequisite for the disclosed ablation processes. The absence of a preparation requirement permits processing to begin at the intended feature location and avoids imposing an unnecessary limitation on workpiece surface condition.

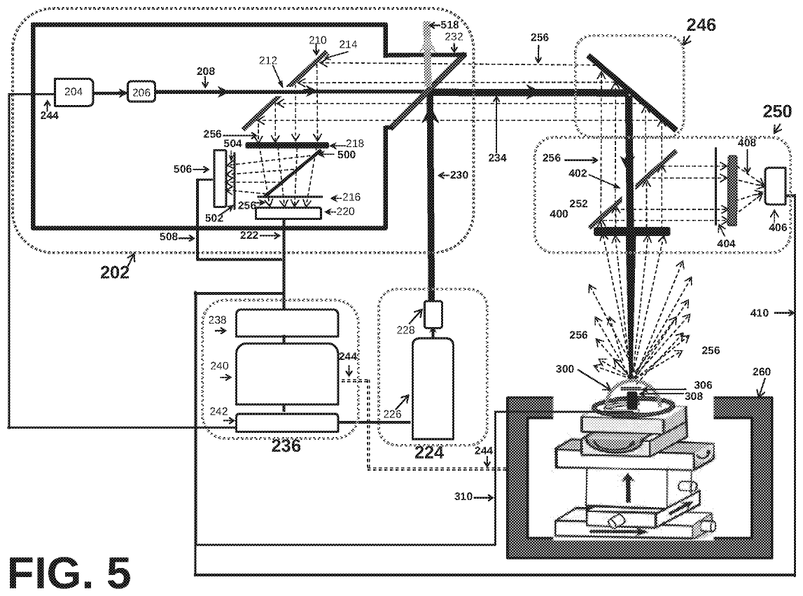

Referring to FIG. 5, the apparatus 200 includes a wavelength-separating optic 500 arranged to divide the returned and/or emitted light 256 into wavelength components for different detector channels. The wavelength-separating optic 500 may comprise a dichroic mirror or another wavelength-selective component having reflection and transmission characteristics selected for the probe wavelength, process wavelength, and one or more plasma-emission wavelengths.

A plasma-emission optical filter 502 is positioned in a plasma-emission detector path. The plasma-emission optical filter 502 transmits a selected plasma-emission wavelength or wavelength band while attenuating probe light, process light, continuum emission, and ambient light.

A plasma-emission condensing optic 504 concentrates optical energy transmitted by the plasma-emission optical filter 502 onto a detector. The plasma-emission condensing optic 504 may comprise a lens, lens group, reflective concentrator, or another optical element selected according to detector size and return-path geometry.

A plasma-emission photodetector 506 receives the concentrated optical energy. The plasma-emission photodetector 506 may be selected according to wavelength, expected signal magnitude, and temporal response. Detector gain and integration interval may be coordinated with a process pulse to avoid saturation during an early intense emission period.

The plasma-emission photodetector 506 supplies a plasma-emission detector signal 508 to the signal analyzer 238. The plasma-emission detector signal 508 may be sampled after a selected delay, integrated over a selected interval, normalized to a calibration measurement, or compared with another detector channel.

During ablation, a laser-induced plasma plume may form above the irradiated region. The plasma plume may emit continuum radiation and discrete spectral lines associated with the ablated material and plasma conditions.

A selected plasma-emission spectral line is chosen according to the workpiece material and intended diagnostic function. For a single-crystal diamond example, a prominent line near approximately 427 nm may be selected, while other materials may use different wavelengths, delays, and integration intervals.

The wavelength-separating optic 500 may direct a first separated wavelength component toward the probe photodetector 220 and a second separated wavelength component toward the plasma-emission optical filter 502 and plasma-emission photodetector 506. The paths may be reversed or otherwise reconfigured according to the selected optical coatings and detector locations.

The beam combiner 232 may allow a partially transmitted process-light component 518 to reach a detector channel within the OSI system 202. This partial transmission may be used to measure process return at a stationary detector, either instead of or in addition to the process-return photodetector 406 located near the COA 250.

The wavelength-separating optic 500 may provide high reflectivity over multiple selected wavelengths or over a selected broad band. A plurality of wavelength-separating optics, optical filters, and photo detectors may be used to measure multiple plasma lines, probe return, process return, or polarization components. The channels may share a common collection path and separate after the optical reflector component 210.

The apparatus control unit 236 may temporally coordinate the probe detector signal 222, process-return detector signal 410, transmitted-light detector signal 310, and plasma-emission detector signal 508. The signals may be acquired sequentially, during partially overlapping windows, or during common integration intervals when wavelength separation permits simultaneous detection.

A combined process decision may be based on a threshold, ratio, difference, temporal derivative, or weighted combination of two or more detector signals. For example, process return and plasma emission may be compared to distinguish low delivered fluence from plume shielding, while probe return and transmitted light may be compared to distinguish surface reflectivity change from wall perforation.

The apparatus may store the multi-channel measurements with the corresponding workpiece coordinates, orientation, pulse parameters, and layer number. The stored measurements may form a multi-channel image or map of the processed surface and may identify regions requiring additional processing or inspection.

The multi-signal arrangement may be used for ablation micro-drilling of a rigid or compliant thin-walled object, surface micro-patterning, groove or crater formation, cutting, cleaning, coating removal, remelting, smoothing, or polymerization. Different detector channels may be enabled or disabled according to the process and workpiece.

The process focal spot and probe focal spot may have a circular, semicircular, square, rectangular, elongated, or line shape. Their intensity profiles may be flat-top, Gaussian, super-Gaussian, multimode, Bessel, Airy, annular, or combined. A line-shaped spot may have a top-hat distribution along the line and a Gaussian distribution transverse to the line, or a substantially uniform distribution along both axes.

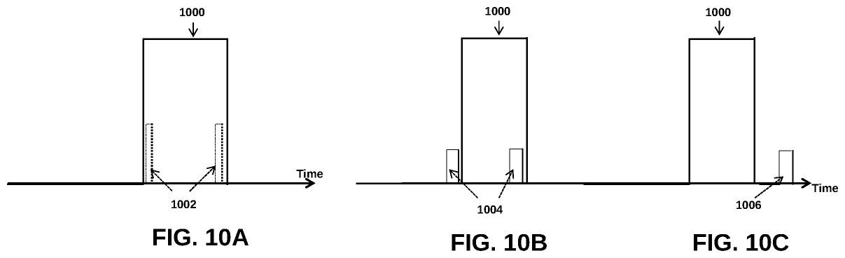

For a plasma-emission measurement, the apparatus control unit 236 may delay sampling after the end of a process pulse by an interval selected to reduce the early continuum contribution. For process-return and probe-return measurements, sampling may occur before, during, or after the process pulse as described with FIGS. 10A-10C.

The multi-signal detector channels may be calibrated using a reference material, a known unmodified region, a known modified region, or an internal optical reference. Calibration values may compensate for detector gain, filter transmission, optical-path loss, source variation, or background illumination.

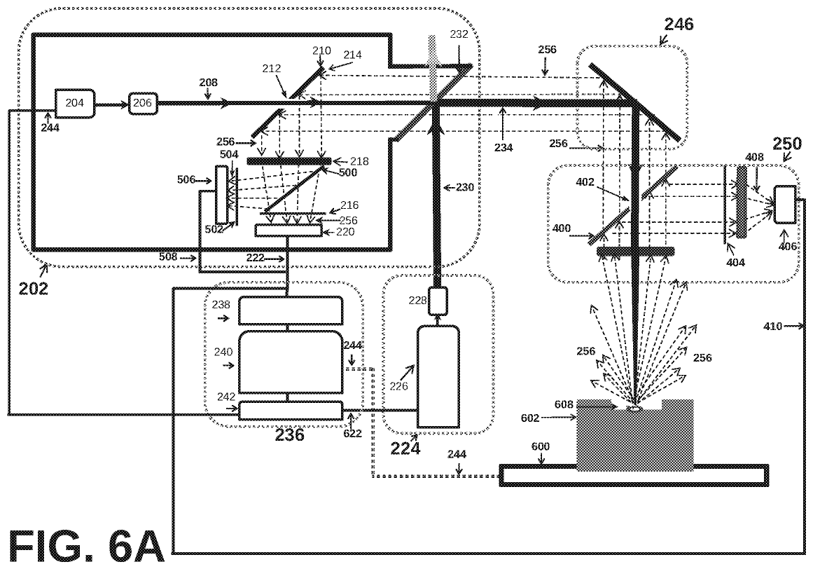

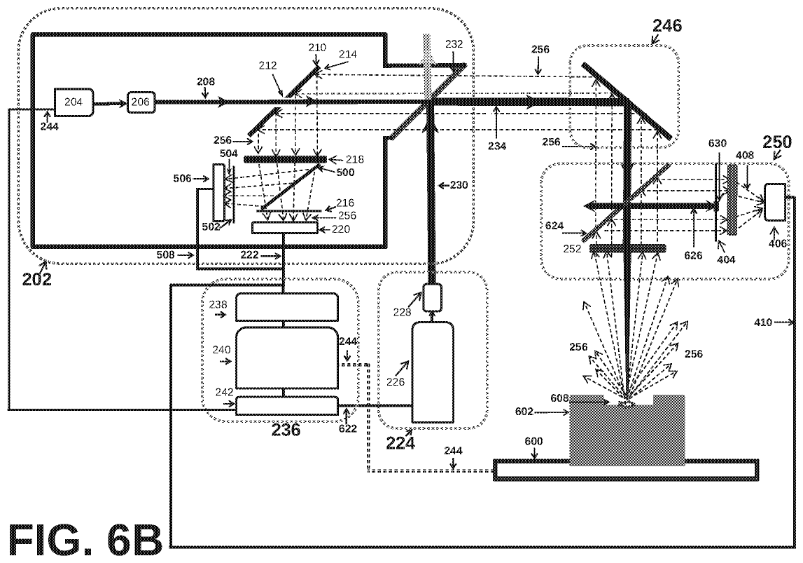

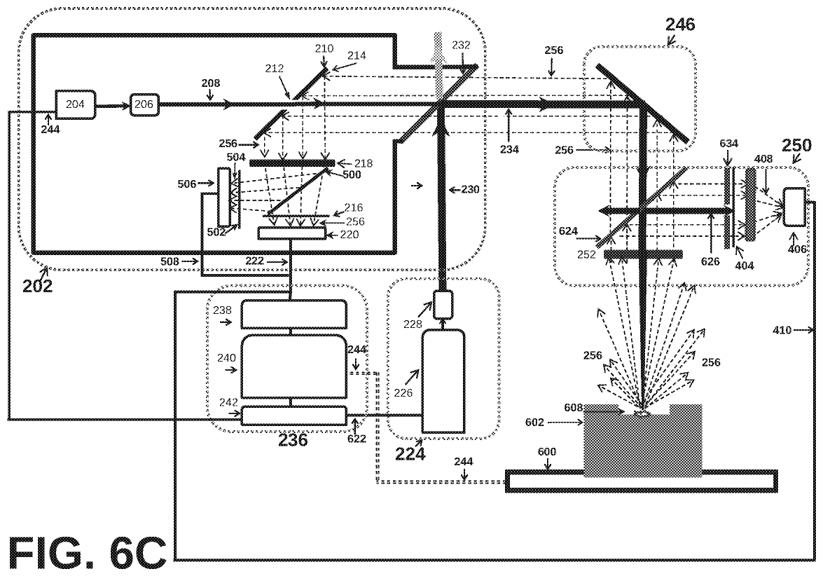

Referring to FIG. 6A, an XYZ positioning system 600 is configured to position an ablation workpiece relative to the process focal spot and probe focal spot during a laser-ablation process. The XYZ positioning system 600 may translate the workpiece along three substantially orthogonal axes while the direction of the process beam 230 and probe beam 208 remains substantially fixed. Alternatively, movement of the XYZ positioning system 600 may be coordinated with beam scanning so that workpiece translation and optical scanning collectively position the process focal spot and probe focal spot at selected locations on the workpiece.

An ablation workpiece 602 is supported by the XYZ positioning system 600. The ablation workpiece 602 may comprise semiconductor material, silicon, silicon carbide, diamond, ceramic, polymer, glass, metal, coating material, composite material, or another material capable of being modified by the process beam 230. The ablation workpiece 602 may have a substantially planar surface, a locally curved surface, a coated surface, or a surface containing previously formed features.

The XYZ positioning system 600 positions an irradiated ablation region relative to the process focal spot and probe focal spot. The irradiated ablation region may correspond to a discrete pulse location, a region within a scan line, a portion of a programmed tool path, or a larger area processed by multiple pulses, passes, or overlapping focal-spot positions. The XYZ positioning system 600 may move continuously or incrementally and may dwell at a selected location for one or more process pulses.

The process beam 230 removes material from the irradiated ablation region to form an ablated feature. The geometry of the ablated feature may be defined by a raster path, vector path, contour path, hatch pattern, spiral path, concentric path, or another programmed processing path. Adjacent irradiated regions may overlap, abut, or remain separated according to the desired feature geometry, surface finish, removal rate, and thermal loading.

The ablated feature may comprise a groove or trench. The groove or trench may be straight, curved, branched, closed, open, continuous, interrupted, or otherwise shaped according to a programmed path. Its width, depth, sidewall geometry, and longitudinal profile may be controlled through focal-spot size, pulse energy, pulse count, scan speed, overlap, focal position, and repeated layer removal.

The ablated feature may additionally or alternatively comprise a crater or pit 610. A crater or pit 610 may be formed by repeatedly irradiating a localized region, by following a spiral or concentric path, or by scanning a defined two-dimensional area. The apparatus may control the diameter, depth, bottom profile, and sidewall angle of the crater or pit 610 by changing the spatial distribution and number of applied pulses.

The ablated feature may additionally or alternatively comprise a blind or through-hole, recess, channel, patterned region, cutting path, or another removed-material geometry. A blind hole may terminate at a selected depth within the ablation workpiece 602, while a through-hole may extend through the full local thickness of the workpiece. The hole may be circular, noncircular, tapered, substantially cylindrical, or otherwise shaped by controlling the beam path and removal sequence.

Material removed during one process pulse, one pulse group, one scan line, one scan pass, or one complete scan over the feature area may define a removed material layer. A removed material layer need not have a perfectly uniform thickness and may represent any controlled depth increment used in the layer-by-layer process. The apparatus control unit 236 may repeat substantially the same processing path or execute a modified path to remove successive layers until a selected depth, geometry, or process endpoint is reached.

The apparatus control unit 236 may adjust the Z position of the XYZ positioning system 600 after removal of one or more removed material layers so that the process focal spot remains at or near an ablated-feature bottom. Z-axis adjustment may compensate for increasing feature depth, changes in the workpiece surface elevation, focal offset, or another geometric condition. The Z position may be changed after each pulse, after a selected group of pulses, after each scan line, after each completed layer, or according to detector feedback.

The ablated-feature bottom may be substantially planar, curved, stepped, tapered, irregular, or otherwise shaped according to the intended feature and removal process. The apparatus control unit 236 may change focal position, process-beam parameters, or tool-path geometry to control the bottom profile and maintain effective energy delivery as the feature deepens.

The apparatus control unit 236 may alter pulse energy, pulse duration, repetition rate, pulse count, scan speed, overlap, focal position, or processing path near an ablated-feature sidewall to obtain a selected feature depth, feature width, sidewall angle, sidewall smoothness, or width-to-depth aspect ratio. Different processing parameters may be applied near the center of the ablated feature and near the ablated-feature sidewall to compensate for changes in optical access, heat accumulation, material redeposition, or local removal rate.

During ablation, ablation debris and/or molten material may be generated together with the laser-induced plasma plume and returned and/or emitted light 256. The ablation debris and/or molten material may include solid particles, droplets, vaporized material, redeposited material, reaction products, coating fragments, or other by-products of the laser-material interaction.

The focusing optics 252 collect at least part of the returned and/or emitted light 256 from the irradiated ablation region. The collected light may include probe return, process-laser return, diffuse scattering, specular reflection, fluorescence, and light emitted by the laser-induced plasma plume. The collected light may be directed to one or more detector channels for measurement before, during, between, or after process pulses.

The signal analyzer 238 may evaluate process return, probe return, plasma emission, or a combination thereof and may generate or support generation of an ablation-process control signal 622. The ablation-process control signal 622 may be used to adjust pulse energy, pulse duration, pulse number, repetition rate, scan speed, focal-spot overlap, focal position, processing path, Z-axis position, or removed-layer increment for the same irradiated ablation region, a later region, or a later material layer.

A process-return measurement may indicate changes in energy coupling, reflectivity, plasma shielding, crater depth, or feature geometry. A probe-return measurement may indicate a change in surface condition, roughness, reflectivity, coating condition, or modification state. A plasma-emission measurement may indicate that ablation is occurring and may provide information concerning the relative strength or condition of the laser-material interaction. The apparatus control unit 236 may analyze these measurements separately or collectively.

For a shallow groove, trench, crater, pit, surface pattern, or other feature that does not require angular correction, the XYZ positioning system 600 may provide sufficient positioning without rotational adjustment. The ablation workpiece 602 may be translated beneath substantially stationary process and probe beams, the beams may be scanned over the ablation workpiece 602, or workpiece motion and beam scanning may be coordinated.

A preliminary surface-conditioning pass is not required before forming the groove or trench, crater or pit 610, blind or through-hole, or another ablated feature. Processing may begin directly on a smooth, rough, coated, uncoated, polished, or comparatively unfinished surface. An optional cleaning, alignment, focus-verification, or calibration pass may be used when independently desired, but such a pass is not required for operation of the disclosed embodiment.

For micro-drilling, repeated process pulses may progressively deepen the blind or through-hole while the Z position is adjusted to maintain the process focal spot near the advancing hole bottom. The process may proceed by stationary percussion drilling, trepanning, spiral scanning, contour scanning, or another pulse-delivery pattern. A change in process return, plasma emission, probe return, transmitted light, commanded depth, or another monitored parameter may indicate completion or breakthrough.

The apparatus control unit 236 may terminate or modify drilling when a through-hole endpoint is detected. For example, a transmitted-light increase may indicate that the hole has penetrated through the workpiece, while a change in process return or plasma emission may indicate a change in material-removal condition. Multiple endpoint indicators may be compared to reduce erroneous endpoint determinations.

For surface micro-patterning or nano-patterning, the apparatus may form grooves, trenches, craters, pits, recesses, channels, holes, or other features that modify surface hardness, friction, wettability, optical absorption, reflectivity, appearance, texture, or another surface property. The pattern may be periodic, nonperiodic, uniform, graded, repeated, localized, or adapted region by region based on inspection results.

For surface cleaning or coating removal, the process beam 230 may remove rust, stain, paint, oxide, contamination, residue, or another surface layer while returned-light measurements distinguish the removable material from the underlying substrate. When the detector data indicates exposure of the underlying substrate, the apparatus control unit 236 may reduce pulse energy, change the scan speed, omit further pulses, or stop processing at that region.

The ablated feature may be inspected between removed material layers, after a selected number of pulses, after a scan pass, or after completion of the feature. Detector data may be used to identify incomplete material removal, excessive depth, sidewall irregularity, nonuniform feature width, redeposition, debris accumulation, or another condition. The apparatus may selectively reprocess an affected location without requiring the entire feature to be processed again.

Inspection data may be associated with X, Y, and Z coordinates of the XYZ positioning system 600. The apparatus control unit 236 may store the measurements as a spatial map of the ablated feature and may use the stored information to control a subsequent layer, correct a feature geometry, or document the completed process.

Referring to FIG. 6B, a wavelength-selective return mirror 624 is positioned in the return-light path of the COA 250. The wavelength-selective return mirror 624 separates portions of the returned and/or emitted light 256 according to wavelength and directs a desired optical component toward a selected detector channel.

The wavelength-selective return mirror 624 may comprise a dichroic mirror or another wavelength-selective optical component having a coating selected to reflect a first wavelength or wavelength band and transmit a second wavelength or wavelength band. The selected reflection and transmission properties may be used to separate probe return, process-laser return, plasma emission, fluorescence, or another diagnostic component contained in the returned and/or emitted light 256.

An undesired specular component 626 may be concentrated near an optical axis or within a relatively small angular region, while a desired scattered and/or emitted component may have a broader angular or spatial distribution. The undesired specular component 626 may comprise strongly reflected probe light, process-laser light, or another optical component that could saturate a photodetector or obscure a weaker diagnostic signal.

A beam blocker 630 may be positioned in the separated return path to block or attenuate the undesired specular component 626 while allowing at least part of the off-axis desired scattered and/or emitted component to propagate toward the detector. The beam blocker 630 may therefore provide spatial separation in addition to the wavelength separation provided by the wavelength-selective return mirror 624.

The beam blocker 630 may comprise an opaque stop, reflective stop, absorbing stop, coated stop, or another optical obstruction. The beam blocker 630 may have a circular, elliptical, rectangular, line-shaped, or other geometry selected according to the spatial distribution of the undesired specular component 626.

The size and position of the beam blocker 630 may be selected according to the outgoing beam diameter, focal length, numerical aperture, return-beam geometry, workpiece reflectivity, detector size, alignment tolerance, and expected angular distribution of the desired scattered and/or emitted component. The beam blocker 630 may be fixed or adjustable and may be positioned at or near a plane in which the undesired specular component 626 is spatially concentrated.

A detector aperture may be positioned between the wavelength-selective return mirror 624 and a corresponding photodetector to limit the detector field of view and reject stray light. The detector aperture may comprise a circular aperture, slit, adjustable iris, field stop, or another spatial-limiting component.

The detector aperture and beam blocker 630 may be positioned in conjugate, near-conjugate, focal, or near-focal planes selected to improve separation between a strong undesired specular component 626 and a weaker desired scattered and/or emitted component. A condensing optic may be positioned downstream of the detector aperture to direct the accepted optical component onto the detector active area.

The wavelength-selective return mirror 624 may transmit the process-laser wavelength and reflect a selected plasma-emission wavelength. Alternatively, the wavelength-selective return mirror 624 may reflect the process-laser wavelength and transmit plasma emission, probe return, or another selected component. The optical relationship may be selected according to detector placement, detector spectral response, and the diagnostic signal being measured.

In another configuration, the wavelength-selective return mirror 624 may separate returned probe light from back-reflected process light. One detector channel may measure probe return, while another detector channel measures process return or plasma emission. Polarization-selective components may additionally be used when the desired and undesired components have different polarization states.

The arrangement of FIG. 6B may be used when a strong specular return would otherwise saturate a detector, reduce measurement resolution, or obscure a weaker diffuse-scattering or plasma-emission signal. The beam blocker 630 may substantially reject the central specular component while allowing useful off-axis light to reach the detector.

The apparatus control unit 236 may compare a detector measurement obtained through the beam blocker 630 and detector aperture with a measurement obtained from another detector channel that receives a different wavelength, angular distribution, polarization, or temporal portion of the returned and/or emitted light 256. The combined measurements may improve discrimination among changes in surface reflectivity, plasma emission, material removal, and feature geometry.

The wavelength-selective return mirror 624, beam blocker 630, and detector aperture may be incorporated into the COA 250 as illustrated, may be located in the OSI system 202, or may be divided between the COA 250 and OSI system 202. Their locations may be selected according to available space, optical-path length, signal strength, alignment, and detector accessibility.

The surface-ablation process described in connection with FIG. 6A may otherwise remain substantially unchanged. The XYZ positioning system 600 may continue to position the ablation workpiece 602, and the apparatus control unit 236 may use the wavelength-and spatially separated detector signal to control formation of the ablated feature.

Referring to FIG. 6C, an annular beam-separation component 634 includes a central pass-through opening. The central pass-through opening permits an outgoing process beam, an outgoing probe beam, a combined outgoing beam, or a closely aligned specular return to pass through a central region, while an annular portion of the annular beam-separation component 634 redirects, transmits, or otherwise separates a broader angular distribution of returned light toward a detector.

The annular beam-separation component 634 may comprise an annular reflector, annular filter, apertured dichroic component, annular mirror, or another optical component having different optical behavior in a central region and an annular region. The central pass-through opening may comprise a physical aperture through the component or an optically transmissive central area surrounded by a reflective or wavelength-selective annular region.

The diameter or cross-sectional dimensions of the central pass-through opening may be selected to pass substantially all of the outgoing process beam 230 and probe beam 208 while limiting interception of the outgoing beams. The surrounding annular region may be sized to intercept at least part of the broader returned and/or emitted light 256 collected by the focusing optics 252.

The annular arrangement may reduce coupling of the undesired specular component 626 into a detector while collecting the desired scattered and/or emitted component. A specular return that remains substantially collinear with the outgoing optical path may pass through the central pass-through opening, while diffuse scattering, off-axis reflected light, fluorescence, or plasma emission having a broader angular distribution is intercepted by the annular region.

The relative dimensions of the central pass-through opening and the annular region may be selected according to numerical aperture, outgoing-beam diameter, return divergence, alignment tolerance, workpiece reflectivity, feature geometry, focal length, and detector sensitivity. A smaller central opening may increase collection of near-axis returned light, while a larger central opening may provide greater tolerance for outgoing-beam alignment and strong specular return.

The annular beam-separation component 634 may reflect the desired scattered and/or emitted component toward a detector while transmitting the undesired specular component 626. Alternatively, the annular region may transmit the desired component while another optical surface redirects it toward the detector. The annular region may also provide wavelength-selective or polarization-selective operation.

The annular beam-separation component 634 may be used alone or together with wavelength filtering, polarization filtering, a detector aperture, a condensing lens, or another optical component. A detector positioned downstream of the annular beam-separation component 634 may measure probe return, process return, plasma emission, fluorescence, polarization-dependent light, or another selected constituent of the returned and/or emitted light 256.

The annular beam-separation component 634 may be located within the COA 250, within the OSI system 202, or at another position in the bidirectional return optical path. In one embodiment, it is positioned at or near a plane where the outgoing beam and specular return are concentrated near the optical axis and the desired diffuse or emitted light occupies a broader area.

The annular return-separation arrangement may be useful during processing of highly reflective materials or during formation of features that produce a strong axial return. The arrangement may reduce detector saturation while retaining useful information from scattered light or light emitted by the laser-material interaction.

The apparatus control unit 236 may compare the signal obtained through the annular return-separation arrangement with probe-return, process-return, plasma-emission, or transmitted-light measurements obtained through another channel. A change in the annularly collected signal may indicate a change in surface roughness, feature depth, material removal, plume formation, or another processing condition.

The surface-ablation process, XYZ positioning operation, layer-by-layer removal, Z-axis focus correction, and detector-based feedback described in connection with FIG. 6A may be used without material change in the embodiment of FIG. 6C. The annular beam-separation component 634 principally provides an alternative arrangement for separating and measuring selected portions of the returned and/or emitted light 256.

The alternative configurations of FIGS. 6A, 6B, and 6C may be selected according to workpiece reflectivity, feature geometry, process-beam wavelength, probe-beam wavelength, expected plasma emission, detector sensitivity, and the relative intensities and angular distributions of specular, diffuse, transmitted, and emitted-light components. The underlying ablation process and XYZ positioning operation may remain substantially the same among the configurations.

In one implementation, the FIG. 6A configuration may be used where conventional wavelength filtering provides adequate signal isolation. The FIG. 6B configuration may be selected where both wavelength separation and rejection of a spatially concentrated specular component are beneficial. The FIG. 6C configuration may be selected where a central outgoing and specular path is to remain substantially unobstructed while a broader annular return distribution is collected.

Features of the FIGS. 6A-6C arrangements may also be combined. For example, the annular beam-separation component 634 may include a wavelength-selective coating, may be used with the detector aperture, or may be followed by an additional optical filter. Similarly, the wavelength-selective return mirror 624 may be used with an annular aperture or other spatial-separation component. Such combinations preserve the inventor's common concept of separating useful diagnostic light from unwanted or overwhelming optical components while monitoring and controlling the laser-ablation process.

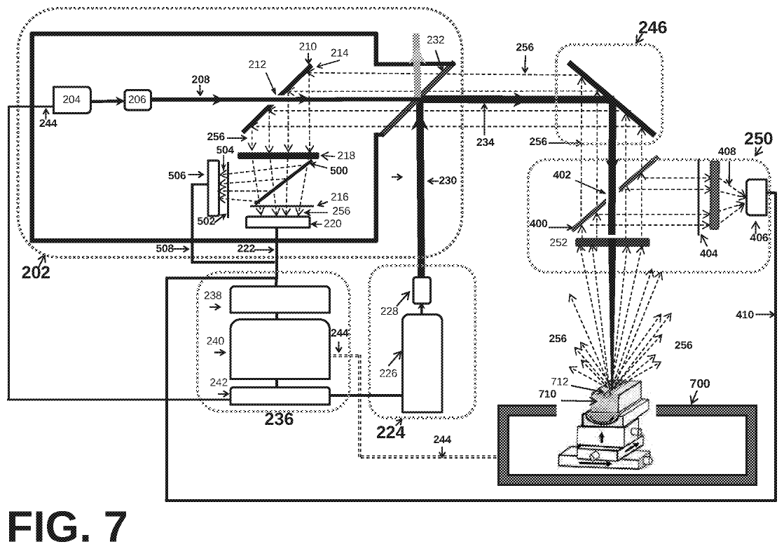

Referring to FIG. 7, a four-axis positioning system 700 is configured to position a cutting workpiece 710 relative to the process focal spot and probe focal spot during laser grooving, trench formation, or ablation cutting. The four-axis positioning system 700 provides coordinated translational and angular positioning so that successive regions of the cutting workpiece 710 may be brought into a selected relationship with the process beam 230 and probe beam 208 as material is removed region by region and layer by layer. The process and probe beams may remain substantially stationary while the cutting workpiece 710 is moved, may be scanned relative to the cutting workpiece 710, or may be positioned through coordinated workpiece motion and beam scanning.

The four-axis positioning system 700 includes an X-axis stage, a Y-axis stage, a Z-axis stage, and a roll stage. The X-axis stage and Y-axis stage provide lateral positioning of the cutting workpiece 710 relative to the process focal spot and probe focal spot, while the Z-axis stage adjusts the relative axial position of the cutting workpiece 710 to maintain the focal spots at or near a region being processed. The roll stage provides angular adjustment of the cutting workpiece 710 about a selected rotational axis during formation of a groove or cutting kerf. The individual stages may be stacked, mechanically coupled, or otherwise arranged to provide the disclosed relative motion, and their movements may be continuous, incremental, point-to-point, or synchronized with delivery of one or more laser pulses.

The cutting workpiece 710 is supported by the four-axis positioning system 700 through an appropriate mounting mechanism. The cutting workpiece 710 may comprise a semiconductor slab, silicon slab, silicon-carbide slab, diamond slab, ceramic, glass, metal, polymer, composite material, or another material capable of being grooved or cut by laser ablation. The mounting mechanism may comprise a clamp, chuck, vacuum fixture, carrier, frame, nest, or another support selected to hold the cutting workpiece 710 without materially obstructing the process beam 230, the probe beam 208, or the collected optical signals.

The process beam 230 forms a groove or cutting kerf 712 in the cutting workpiece 710 by removing material from successive irradiated regions and successive depth increments. The groove or cutting kerf 712 may be initiated at the top surface of the cutting workpiece 710 and progressively deepened through repeated delivery of laser pulses. The process may terminate at a selected depth to form a groove or trench or may continue through the entire local thickness of the cutting workpiece 710 to perform ablation cutting and separate one portion of the workpiece from another.

The groove or cutting kerf 712 includes a kerf bottom, a first kerf sidewall, and a second kerf sidewall opposite the first kerf sidewall. The kerf bottom represents the surface region at which material is currently being removed, while the first and second kerf sidewalls, define opposite lateral boundaries of the kerf. The kerf bottom and sidewalls, may be substantially planar, tapered, stepped, curved, or otherwise shaped according to the focal-spot geometry, pulse parameters, workpiece material, scan path, and angular position of the cutting workpiece 710.

A kerf centerline and/or roll axis extends generally along the groove or cutting kerf 712 and may be located at or near the middle of the kerf bottom. The roll stage may rotate the cutting workpiece 710 about the kerf centerline and/or roll axis so that the relative angle between the process beam 230 and the kerf bottom can be changed as the process focal spot moves across the kerf width. The roll axis may be aligned with the longitudinal direction of the groove or cutting kerf 712, although a selected offset may be used where required by the workpiece geometry or mounting arrangement.

The X-axis stage and Y-axis stage position successive irradiated regions along a cutting path. The cutting path may be straight, curved, closed, open, segmented, contour-following, or otherwise programmed according to the desired groove or separated geometry. The X-axis stage and Y-axis stage may move the cutting workpiece 710 continuously beneath the process beam 230 or may advance the workpiece in discrete increments corresponding to individual pulse locations, groups of pulses, scan lines, or feature segments.

Repeated irradiation removes a removed cutting layer from the cutting workpiece 710. A removed cutting layer may correspond to material removed by a single pulse, a selected group of pulses, one scan line, one scan pass, or one complete traversal of the cutting path. The thickness of a removed cutting layer may be substantially uniform or may vary across the kerf according to local fluence, beam incidence, material condition, feature depth, and detector-based process adjustments. Successively removed cutting layers may progressively deepen the groove or cutting kerf 712 until a selected groove depth or complete separation is achieved.

The Z-axis stage may adjust the position of the cutting workpiece 710 after removal of one or more removed cutting layers so that the process focal spot remains at or near the kerf bottom. The Z-axis stage may be updated after each pulse, after a selected pulse group, after a scan line, after a complete layer, or in response to optical feedback. Maintaining the process focal spot near the advancing kerf bottom may improve removal consistency and reduce defocus as the kerf depth increases.

A focal-spot lateral position identifies the position of the process focal spot across the width of the groove or cutting kerf 712. The focal-spot lateral position may be controlled through movement of the X-axis stage or Y-axis stage, through beam scanning, or through a combination of stage motion and optical scanning. The focal-spot lateral position may be located near the kerf centerline, near the first kerf sidewall, near the second kerf sidewall, or at an intermediate location according to the portion of the kerf being processed.

The roll stage provides an angular adjustment 728 that changes the angle of incidence of the process beam 230 at the kerf bottom. Rotating the cutting workpiece 710 about the kerf centerline and/or roll axis may improve optical access to a selected portion of the kerf bottom and reduce obstruction of the process beam 230 by the first or second kerf sidewall,. The angular adjustment 728 may therefore improve delivery of laser energy to regions near a kerf sidewall that would otherwise be partially shadowed or blocked as the kerf becomes deeper.

A kerf depth increases as successive removed cutting layers are removed. For a selected focal-spot size, kerf width, and sidewall geometry, a permitted or commanded magnitude of angular adjustment 728 may increase as the kerf depth increases. A relatively shallow groove may require little or no angular adjustment, while a deeper groove may require greater angular adjustment to maintain optical access to the kerf bottom adjacent to one of the sidewalls,. The selected angular adjustment may also depend on the focal-spot lateral position relative to the kerf centerline and the first and second kerf sidewalls.

When the process focal spot is positioned near the middle of the kerf width, the cutting workpiece 710 may be held at or near a neutral angular position. As the process focal spot approaches the first kerf sidewall, the roll stage may rotate the cutting workpiece 710 in a first angular direction to improve access to the kerf bottom adjacent to the first kerf sidewall. As the process focal spot approaches the second kerf sidewall, the roll stage may rotate the cutting workpiece 710 in an opposite angular direction. The angular adjustment may occur continuously across the kerf width or may be implemented through a series of discrete angular positions.

The angular adjustment 728 may be selected so that the process beam 230 impinges the kerf bottom at a desired angle while avoiding excessive irradiation of the first or second kerf sidewall,. The angle may be limited to prevent contact between the cutting workpiece 710 and surrounding apparatus components, avoid excessive beam reflection toward the focusing optics 252, maintain acceptable detector collection geometry, or preserve dimensional accuracy of the groove or cutting kerf 712.

The apparatus control unit 236 may coordinate movement of the X-axis stage, Y-axis stage, Z-axis stage, and roll stage with delivery of process pulses and sampling of detector signals. The apparatus control unit 236 may command a lateral position, focal depth, and roll angle for each irradiated region or each portion of a removed cutting layer. The stage commands may be generated from a stored processing recipe, workpiece model, cutting path, calibration data, detector feedback, or a combination thereof.

The Z position may be updated after one pulse, a selected group of pulses, one scan line, one complete removed cutting layer, or another processing increment. The roll angle may be updated continuously as the focal-spot lateral position moves across the kerf width or may be changed at selected locations near the first and second kerf sidewalls,. The apparatus control unit 236 may coordinate Z adjustment and roll adjustment so that the process focal spot remains near the kerf bottom while the process beam 230 maintains a selected angle of incidence.

The angular adjustment 728 may improve process-energy coupling, kerf-width uniformity, sidewall straightness, and kerf-wall quality. By reducing beam blockage and maintaining more consistent irradiation of the kerf bottom, the system may reduce taper, irregular sidewall formation, incomplete material removal, and nonuniform kerf width. Angular adjustment may also improve collection of process return, probe return, or plasma emission from the kerf bottom by reducing line-of-sight obstruction caused by the kerf sidewalls.

The process focal spot may be line-shaped with a top-hat intensity distribution along the length of the line and a Gaussian distribution transverse to the line. Alternatively, the process focal spot may be rectangular with a selected aspect ratio and a substantially uniform intensity distribution, or may have another focal-spot shape and profile described in connection with the preceding embodiments. A line-shaped or rectangular focal spot may be aligned substantially parallel with the longitudinal direction of the groove or cutting kerf 712, substantially transverse to that direction, or at another selected orientation according to the desired material-removal pattern.

The probe focal spot may be substantially superimposed on the process focal spot, may partially overlap the process focal spot, or may be spatially offset. A leading probe focal spot may inspect a region before ablation, while a trailing probe focal spot may inspect the kerf bottom or a sidewall after material removal. The selected focal-spot relationship may be maintained as the workpiece is translated and rotated.

The apparatus control unit 236 may determine the angular adjustment 728 from a programmed relationship among kerf depth, focal-spot lateral position, kerf width, focal-spot size, and sidewall geometry. The relationship may be stored as a table, mathematical expression, process recipe, tool path, or sequence of stage commands. The programmed angular adjustment may define a neutral angle near the kerf centerline and progressively increasing angles toward the first and second kerf sidewalls.

Detector feedback may modify the programmed angular adjustment when measured optical coupling or feature condition differs from an expected result. For example, a decrease in process-return intensity, an unexpected change in plasma emission, or a probe-return measurement indicating incomplete material removal may cause the apparatus control unit 236 to modify the roll angle, Z position, pulse energy, scan speed, or number of pulses. Feedback may be applied to the same region, a subsequent region, or a later removed cutting layer.

The process may form a narrow trench, divide a slab, cut a straight or curved contour, or produce a plurality of thin wafers through repeated cutting operations. Each cutting operation may form a separate groove or cutting kerf 712. Reducing kerf width reduces the amount of material lost during separation and may increase the number of wafers or components obtained from a slab. Improved kerf uniformity and sidewall quality may also reduce subsequent finishing operations and improve dimensional consistency of the separated articles.

In a semiconductor application, the cutting workpiece 710 may comprise silicon or silicon carbide and may be cut into thinner wafers or components. In a diamond application, the cutting workpiece 710 may comprise a single-crystal diamond slab that is divided into thin diamond wafers. Because silicon carbide and diamond may be comparatively valuable or difficult to process, reduction of kerf loss and improvement of kerf consistency may provide increased material yield.

The apparatus may measure process return, probe return, and plasma emission during grooving or cutting. Process-return intensity may indicate delivered energy coupling, reflectivity change, plasma shielding, or geometric obstruction within the kerf. Plasma emission may indicate the presence and relative intensity of ablation activity. Probe return may indicate surface condition, bottom condition, sidewall condition, or completion of a material-removal increment.

The detector signals may be used separately or in combination to adjust pulse energy, pulse duration, pulse count, repetition rate, Z position, roll angle, focal-spot lateral position, layer increment, or scan speed. A combined analysis may help distinguish insufficient fluence from excessive plume shielding or sidewall blockage. Detector measurements may be associated with the corresponding stage coordinates and stored as a spatial record of the groove or cutting kerf 712.

In another application, the four-axis positioning system 700 may be used to micro-drill a hole in a thin-walled cylindrical, tubular, balloon-shaped, or otherwise curved object. The roll stage may orient successive circumferential regions relative to the process beam 230, while the X-axis stage, Y-axis stage, and Z-axis stage position the selected region and maintain focus. A transmitted-light detector positioned on the opposite side of the wall may be used to identify breakthrough or completion of a through-hole.

The grooving, micro-drilling, or cutting process may begin directly on a smooth or rough starting surface without a separate conditioning pass. The disclosed process does not require preliminary remelting, polishing, smoothing, or other surface preparation before material removal begins. The apparatus may nevertheless obtain a baseline optical measurement, verify focus, perform alignment, or conduct an optional cleaning or calibration operation before initiating ablation when independently desired.

The apparatus may form a deep groove or trench without completely separating the cutting workpiece 710. A final groove depth may be determined from a commanded Z position, number of removed cutting layers, measured process return, probe return, plasma emission, transmitted light, or another endpoint measurement. Processing may terminate when the selected depth, optical condition, or dimensional result is reached.

When the process continues through the entire local thickness of the cutting workpiece 710, a cut-through or breakthrough condition may be identified from a change in process-return intensity, transmitted light, probe return, plasma emission, mechanical separation, or commanded depth. Upon detection of breakthrough, the apparatus control unit 236 may stop the process beam 230, reduce energy, move to another cutting path, or initiate a finishing or inspection pass.

The apparatus control unit 236 may compensate for stage error, workpiece tilt, surface-height variation, mechanical runout, or changing focal position by modifying one or more stage commands. Calibration may establish a relationship among stage coordinates, workpiece geometry, focal position, kerf centerline, and the rotational axis of the roll stage before processing begins. Calibration may be performed using encoder data, a reference surface, optical measurements, or a known workpiece feature.

The four-axis positioning arrangement may also be combined with beam scanning or movement of the COA 250. In one configuration, the X-axis stage and Y-axis stage provide larger-scale positioning while optical scanning provides rapid local movement within a selected field. In another configuration, the COA 250 provides one or more translational movements while the cutting workpiece 710 is positioned by the Z-axis stage and roll stage. The relevant consideration is the resulting relative X, Y, Z, and angular positioning between the process focal spot and the cutting workpiece 710.

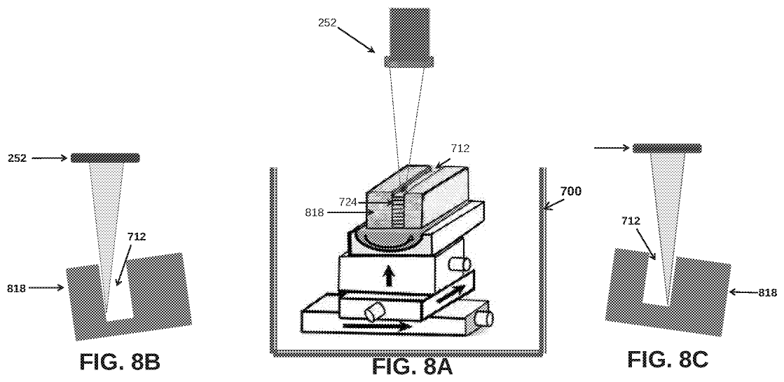

Referring to FIG. 8A, the cutting workpiece 710 may be held in a neutral angular workpiece position while the process beam 230 removes material from a central portion of the groove or cutting kerf 712. In the neutral angular workpiece position, the cutting workpiece 710 may be oriented so that the process beam 230 is substantially normal to the kerf bottom, or is directed at another selected nominal angle appropriate for the workpiece material, focal-spot geometry, and cutting process. The neutral angular workpiece position may be used during initiation of the groove or cutting kerf 712, during removal of material near the kerf centerline, or while the kerf remains sufficiently shallow that the first and second kerf sidewalls, do not materially obstruct delivery of the process beam 230 to the kerf bottom.

FIG. 8B illustrates a first angular workpiece position in which the cutting workpiece 710 is rotated in a first direction relative to the process beam 230. The first angular workpiece position may be selected to improve optical access to a portion of the kerf bottom adjacent to the first kerf sidewall. By rotating the cutting workpiece 710 about or substantially about the kerf centerline and/or roll axis, the apparatus may reduce blockage of the process beam 230 by the first or second kerf sidewall and may direct a greater portion of the process-beam energy toward a selected lateral portion of the kerf bottom.

FIG. 8C illustrates a second angular workpiece position in which the cutting workpiece 710 is rotated in a second direction opposite the first angular workpiece position. The second angular workpiece position may improve optical access to a portion of the kerf bottom adjacent to the second kerf sidewall. The first and second angular workpiece positions, may have substantially equal and opposite angular magnitudes, or their angular magnitudes may differ according to workpiece geometry, sidewall geometry, focal-spot lateral position, material-removal characteristics, or detector measurements.

The neutral angular workpiece position and the first and second angular workpiece positions, represent selected positions within a range of available angular orientations. The cutting workpiece 710 need not stop at only the three illustrated positions. The roll stage may move the cutting workpiece 710 continuously through intermediate angular positions, may move between discrete programmed angular positions, or may use a combination of continuous and incremental motion. Angular position may be changed within a removed cutting layer, between successive removed cutting layers, at selected focal-spot lateral positions, or when the kerf depth reaches one or more predetermined values.

In one cutting sequence, material near the center of the groove or cutting kerf 712 may be removed while the cutting workpiece 710 is in the neutral angular workpiece position. The cutting workpiece 710 may then be moved to the first angular workpiece position while material is removed adjacent to one kerf sidewall and moved to the second angular workpiece position while material is removed adjacent to the opposite kerf sidewall. This sequence may be repeated for each removed cutting layer or may be modified as the groove or cutting kerf 712 deepens.

In another cutting sequence, the roll angle may vary substantially continuously as the process focal spot moves across the width of the groove or cutting kerf 712. The cutting workpiece 710 may remain near the neutral angular workpiece position while the process focal spot is near the kerf centerline, progressively rotate toward the first angular workpiece position as the process focal spot approaches the first kerf sidewall, and progressively rotate toward the second angular workpiece position as the process focal spot approaches the second kerf sidewall.

The selected angular position may depend on focal-spot size, focal-spot shape, kerf width, kerf depth, sidewall angle, material, pulse energy, layer increment, and optical access to the kerf bottom. A relatively shallow groove or cutting kerf 712 may require little or no angular adjustment, while a deeper kerf may require progressively greater angular adjustment to reduce beam obstruction by the sidewalls,. The apparatus control unit 236 may determine the angular position from a stored process recipe, a programmed relationship to kerf depth and focal-spot lateral position, detector feedback, or a combination thereof.

An optional assist-gas assembly may be used during layer-by-layer grooving, drilling, cutting, surface cleaning, coating removal, or another laser modification process. The assist-gas assembly may operate while the cutting workpiece 710 is in the neutral angular workpiece position, the first angular workpiece position, the second angular workpiece position, or an intermediate position.

The assist-gas assembly includes a pressurized gas source. Argon is one example of a suitable assist gas, although nitrogen, air, helium, or another gas compatible with the workpiece material and intended process may be used. The gas may be selected to provide a desired mechanical debris-removal effect, thermal effect, or chemical environment near the irradiated region. An inert gas may be selected when reduction of oxidation or burning is desired, while another gas may be selected when a different interaction with the workpiece or ablation by-products is beneficial.

An assist-gas nozzle is positioned adjacent to the process-beam path and directs gas toward the focal region and the groove or cutting kerf 712. The assist-gas nozzle may be oriented so that the gas flows toward the kerf bottom, along the longitudinal direction of the cutting path, across the kerf width, or toward an extraction conduit 814. The assist-gas nozzle may be fixed relative to the COA 250, supported by a separate mount, or carried by a movable support coordinated with the position and orientation of the cutting workpiece 710.

An assist-gas stream may be directed alongside, obliquely toward, or substantially coaxially with the process beam 230. The assist-gas stream may enter the groove or cutting kerf 712 and mechanically remove molten material, particles, vapor, and debris generated during ablation. Removal of the ablation by-products may improve delivery of the process beam 230 to the kerf bottom, reduce redeposition on the kerf sidewalls, and reduce obstruction of returned or emitted light collected by the focusing optics 252.

The assist-gas stream may also evacuate or displace at least part of the laser-induced plasma plume, influence chemical reactions at the irradiated region, reduce oxidation or burning, and limit accumulation of heat or reaction products. The assist-gas stream may further reduce upward transport of particles toward the beam-delivery optics, the COA 250, and the focusing optics 252, thereby reducing contamination of optical surfaces.

The gas pressure, flow rate, nozzle opening, nozzle orientation, and distance between the assist-gas nozzle and the cutting workpiece 710 may be selected according to workpiece material, feature geometry, kerf depth, pulse parameters, debris-removal requirements, and the mechanical stability of the workpiece. A deeper kerf may use a gas orientation or pressure selected to promote flow into the kerf and evacuation of material from the kerf bottom. For a thin, flexible, or compliant workpiece, the gas flow may be limited to reduce undesired movement or deformation.

The assist-gas flow may remain substantially continuous while laser processing is in progress and need not be synchronized with individual process-laser pulses. Gas flow may begin before delivery of the first process pulse to establish a selected local environment, remain active during formation of one or more removed cutting layers, and continue for a selected interval after processing to remove residual particles, vapor, or heat. In another implementation, gas flow may be enabled and disabled between processing regions, cutting paths, or workpieces without requiring pulse-level timing.

An optional extraction conduit 814 may be positioned near the groove or cutting kerf 712 to receive particles, gases, vapor, and other by-products displaced by the assist-gas stream or otherwise released by the ablation process. The extraction conduit 814 may be positioned on a side of the processing region opposite the assist-gas nozzle so that the gas flow tends to carry debris toward the extraction conduit 814. Alternatively, the assist-gas nozzle and extraction conduit 814 may be positioned according to available access, workpiece orientation, plume direction, and cutting-path geometry.

The extraction conduit 814 may be coupled to an extraction system configured to create a negative pressure or directed flow that evacuates particles, contaminants, paint dust, process gases, vapor, smoke, coating fragments, and other by-products generated during ablation cutting, surface cleaning, paint or coating removal, or another laser modification process. The extraction system may include a vacuum source, blower, separator, collector, filter, or other component appropriate for receiving and containing the removed material.

The assist-gas assembly and extraction system may be used together or independently. When used together, the assist-gas stream may dislodge or transport ablation debris, while the extraction system receives and removes the displaced material from the processing region. When assistance gas is not required, the extraction system may independently collect naturally expanding plume material or particles. When extraction is not required, the assist-gas assembly may direct debris away from the workpiece and optical components.

The assist-gas nozzle and extraction conduit 814 may be carried by the COA 250, by a separate support, by a robotic assembly, or by another movable mechanism coordinated with workpiece position. Their positions may be adjusted as the cutting workpiece 710 moves among the neutral, first, and second angular workpiece positions,, Such adjustment may maintain a desired relationship among the gas stream, extraction flow, process focal spot, and groove or cutting kerf 712.

The apparatus control unit 236 may coordinate operation of the four-axis positioning system 700, the process-laser source 226, the detector channels, the assist-gas assembly, and the extraction system. Control may include commanding X, Y, Z, and roll positions; triggering process pulses; establishing detector sampling windows; enabling gas flow; and operating the extraction system. The apparatus control unit 236 may adjust one or more of these operations in response to measured process return, probe return, plasma emission, transmitted light, or another process condition.

A semiconductor, diamond, or other slab 818 may be processed region by region and layer by layer until a selected kerf depth is reached or complete separation occurs. The slab 818 may comprise silicon, silicon carbide, single-crystal diamond, another semiconductor, ceramic, glass, or another technical material. The process may form one groove or cutting kerf 712 or may form multiple substantially parallel or otherwise arranged kerfs to divide the slab 818 into a plurality of thinner articles.

Repeated cutting operations may separate one or more wafers from the slab 818. Each cutting operation may form a separate groove or cutting kerf 712 extending through the slab 818. Kerf width, removed-layer thickness, roll angle, pulse energy, repetition rate, focal-spot shape, focal-spot lateral position, and cutting path may be selected to reduce material waste and maintain substantially uniform wafer thickness.

The process focal spot may be positioned at or near the kerf bottom as each removed cutting layer is formed. The apparatus may compensate for changes in beam incidence and optical path length caused by roll movement by adjusting the Z-axis position together with the angular position. Coordinated Z and roll adjustment may maintain the process focal spot near the kerf bottom and maintain the probe focal spot in a selected superimposed, overlapping, leading, or trailing relationship with the process focal spot.

A cut-through or breakthrough endpoint 822 may be identified using a commanded kerf depth, a known workpiece thickness, an increase or other change in transmitted light, a change in process return, a change in probe return, a change in plasma emission, mechanical separation, or another detectable condition. The apparatus control unit 236 may analyze one endpoint signal or combine multiple endpoint indications to reduce the likelihood of stopping before complete separation or unnecessarily irradiating the workpiece after separation.

When the cut-through or breakthrough endpoint 822 is detected, the apparatus control unit 236 may stop delivery of process pulses, reduce pulse energy, increase scan speed, discontinue repetition of the cutting path, move the cutting workpiece 710 to a subsequent cutting location, or initiate an inspection operation. Gas flow or extraction may continue for a selected interval after laser processing stops to remove remaining debris and vapor.

During cutting, the apparatus may use the process-return detector signal 410 and plasma-emission detector signal 508 to maintain delivered fluence and material removal within a desired range as the kerf depth increases. Process-return intensity may indicate energy coupling, reflection from the kerf bottom, or obstruction by a sidewall or plume. Plasma-emission intensity may indicate whether ablation is occurring and may identify a change in interaction conditions.

Probe-return measurements may inspect the kerf bottom, the first and second kerf sidewalls,, or a recently processed region. A transmitted-light measurement may indicate thinning, breakthrough, or complete separation. The apparatus control unit 236 may compare these measurements to distinguish insufficient fluence, effective ablation, excessive plume shielding, sidewall obstruction, debris accumulation, or completion of the cutting process.

The cutting sequence may remove an initial portion of a removed cutting layer while the cutting workpiece 710 is in the neutral angular workpiece position and may use the first and second angular workpiece positions, to remove portions adjacent to the respective kerf sidewalls. The order of the angular positions may be changed, and one angular position may be used more frequently than another where the kerf geometry or workpiece configuration is asymmetric.

Alternatively, the angular workpiece position may vary continuously across the kerf width during each removed cutting layer. The apparatus control unit 236 may coordinate the roll angle with the focal-spot lateral position so that angular adjustment is near zero at the kerf centerline and increases as the process focal spot approaches a kerf sidewall. The amount of angular adjustment may also increase as the kerf depth increases.

The neutral angular workpiece position and first and second angular workpiece positions, may be calibrated relative to the process-beam path before cutting begins. Calibration may account for stage alignment, workpiece tilt, the position of the kerf centerline, the focal length of the focusing optics 252, and the rotational axis of the roll stage. Detector feedback may be used to refine the calibrated angular positions during processing.

The layer-by-layer cutting method may be applied to single-crystal diamond, silicon, silicon carbide, or another semiconductor or technical material. A single-crystal diamond slab may be separated into diamond wafers used in semiconductor, thermal-management, optical, or other technical applications in which diamond properties are beneficial. Reduction in cutting-kerf width may reduce loss of valuable material and increase the number of usable wafers obtained from a slab.

The disclosed angular-position, assist-gas, extraction, and detector-feedback features may be used in different combinations. A cutting process may employ angular adjustment without assist gas, assist gas without extraction, extraction without angular adjustment, or all of the disclosed features together. A particular implementation may select the combination appropriate for the material, workpiece geometry, feature depth, desired kerf quality, and available optical access.

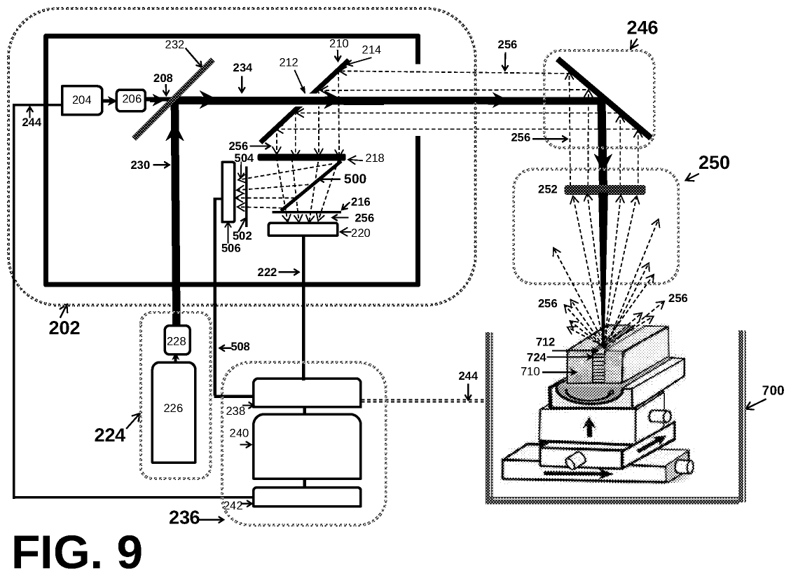

Referring to FIG. 9, an alternative integrated optical architecture locates returned-light separation components and multiple detector channels primarily within the optical surface inspection (OSI) system 202. The alternative integrated optical architecture may retain the process-laser system 224, apparatus control unit 236, turning optics 246, control optics assembly (COA) 250, focusing optics 252, and positioning arrangements described in connection with the preceding embodiments. Relocating the principal detector channels to the OSI system 202 permits the detector components to remain substantially stationary while the COA 250 or workpiece is translated, rotated, or otherwise repositioned.

The probe source 204 generates the probe beam 208, and the process-laser source 226 generates the process beam 230. The beam combiner 232 combines the process beam 230 and probe beam 208 so that the beams propagate along at least a portion of a common optical path. The combined beams are directed through or adjacent to the optical reflector component 210, through the turning optics 246, and toward the COA 250. The focusing optics 252 focus the process beam 230 and probe beam 208 at a selected irradiated surface region of the workpiece.

The process beam 230 may modify the irradiated surface region by ablation, drilling, grooving, cutting, cleaning, coating removal, remelting, smoothing, texturing, patterning, polymerization, heat treatment, or another laser-induced process. The probe beam 208 may inspect the same irradiated surface region before, during, or after processing. The process and probe focal spots may be substantially superimposed, partially overlapping, adjacent, or spatially separated according to the desired pre-process or post-process inspection sequence.

The focusing optics 252 collect at least part of the returned and/or emitted light generated at or near the irradiated surface region. The collected light may include diffusely scattered or specularly reflected probe light, back-reflected process-laser light, fluorescence, polarization-dependent light, and light emitted by a laser-material interaction, including emission from a laser-induced plasma plume. The focusing optics 252 may substantially collimate at least a portion of the collected light before the light propagates away from the workpiece.

The returned and/or emitted light follows an alternative return-light path through the COA 250 and turning optics 246 toward the OSI system 202. At least part of the alternative return-light path may coincide with the outgoing common optical path used to deliver the process beam 230 and probe beam 208. The outgoing and return paths need not be identical for every constituent wavelength over their entire lengths, and wavelength-selective, polarization-selective, partially reflective, or apertured optical components may establish shared and separated portions of the paths.

The optical reflector component 210 includes the pass-through opening 212 and the reflective surface 214 surrounding at least part of the pass-through opening 212. The outgoing probe beam 208, and in some configurations the outgoing combined process-and-probe beam, may pass through the pass-through opening 212. Returned light having a broader angular or spatial distribution than the outgoing beam is intercepted by the reflective surface 214 and redirected toward one or more detector channels within the OSI system 202.

A relatively concentrated specular return that remains substantially aligned with the outgoing optical axis may pass through the pass-through opening 212 rather than being directed toward the detector channels. This arrangement may reduce detector saturation or interference caused by a strong specular component while allowing broader diffuse-scattered or emitted-light components to be collected by the reflective surface 214. The dimensions of the pass-through opening 212 and reflective surface 214 may be selected according to outgoing-beam diameter, return-light divergence, numerical aperture, workpiece reflectivity, and alignment tolerance.

The reflective surface 214 directs a portion of the returned and/or emitted light toward a first alternative detector channel and a second alternative detector channel. The first and second alternative detector channels, may be optically separated by one or more wavelength-separating optics, dichroic mirrors, optical filters, polarization-selective components, beam splitters, apertures, or condensing optics. Each detector channel may include a photodetector having a spectral response and temporal response appropriate for the optical component being measured.

The first alternative detector channel may measure returned probe light, while the second alternative detector channel may measure light emitted by a laser-induced plasma plume. In another configuration, one detector channel may measure probe return, and the other detector channel may measure back-reflected process-laser light. Other technically compatible combinations may include separate measurements of two plasma-emission wavelengths, two polarization components, diffuse and specular returns, or optical signals acquired during different temporal sampling intervals.

The first and second alternative detector channels, need not be limited to two specific wavelengths or detector functions. Additional detector channels may be provided when measurement of additional constituent wavelengths, polarization states, angular components, or temporal components is desired. Conversely, a particular implementation may use only one of the alternative detector channels where a single diagnostic signal provides sufficient process information.

Optical filters associated with the first and second alternative detector channels, may attenuate process-laser radiation, probe radiation, continuum emission, ambient illumination, or another undesired optical component while transmitting a selected wavelength or wavelength band. A detector channel configured to measure plasma emission may include a narrow-band optical filter selected for a material-dependent spectral line. A detector channel configured to measure probe return may include an optical filter centered at the probe wavelength and may additionally include a polarizer or analyzer.

The detector channels may be sampled before, during, or after a process-laser pulse. The apparatus control unit 236 may establish separate detector-gating or integration intervals for the first and second alternative detector channels,. For example, a probe-return measurement may be obtained before a process pulse or near the end of the pulse, while a plasma-emission measurement may be obtained after a selected delay following the process pulse. The detector channels may operate sequentially, during partially overlapping intervals, or simultaneously when wavelength separation permits.

The alternative architecture may be selected when it is desirable to keep multiple photodetectors, filters, signal-conditioning components, and associated electronics stationary within the OSI system 202 rather than carrying those components with the COA 250. A stationary detector arrangement may reduce moving mass, simplify electrical and thermal connections, improve detector accessibility, and maintain stable alignment among the detector channels. The COA 250 may therefore remain comparatively compact and may be more readily mounted on a movable stage, robotic manipulator, articulated arm, gantry, or mobile platform.

A process-return photo detector may nevertheless remain within or near the COA 250 when local collection provides a stronger, shorter, or more direct process-return path. Accordingly, the alternative integrated optical architecture may use detector channels located entirely within the OSI system 202 or may use a distributed arrangement in which one or more detector channels are located within the OSI system 202 and another detector channel is located within or adjacent to the COA 250.

The four-axis positioning system 700 may support a cutting workpiece 710 having a groove or cutting kerf 712 and may provide X, Y, Z, and roll motion as described in connection with FIG. 7. The X-and Y-axis stages may position successive regions along a cutting path, the Z-axis stage may maintain the process focal spot near the kerf bottom as the kerf deepens, and the roll stage may adjust the workpiece angle to improve optical access adjacent to the kerf sidewalls.

The apparatus control unit 236 coordinates detector sampling, operation of the process-laser source 226, workpiece position, focal position, and angular adjustment through the control and data link 244. Each detector measurement may be associated with a corresponding workpiece position, workpiece orientation, process-pulse number, focal-spot position, and removed-material layer. The resulting data may be stored as a spatially indexed process record, image, profile, or map.

The alternative integrated optical architecture may form a groove of selected width, depth, sidewall angle, and longitudinal geometry or may continue removing material through the full local thickness of the cutting workpiece 710. Material may be removed region by region and layer by layer. After removal of one layer or a selected group of layers, the apparatus control unit 236 may adjust Z position, workpiece angle, pulse energy, pulse count, scan speed, or overlap according to detector measurements.

The first and second alternative detector channels, may provide feedback for controlling delivered fluence, focal position, scan path, layer increment, roll angle, or endpoint detection. For example, process-return intensity may indicate energy coupling or geometric obstruction, probe return may indicate surface or sidewall condition, and plasma-emission intensity may indicate whether ablation is occurring. A change in one or more detector signals may identify incomplete removal, excessive plume shielding, feature-depth effects, or completion of a cutting operation.

The apparatus control unit 236 may analyze the first and second detector signals separately or in combination. A control decision may be based on a threshold, ratio, difference, temporal change, normalized value, or another relationship between the signals. Comparison of multiple optical measurements may help distinguish a change caused by material removal from a change caused by source variation, workpiece reflectivity, detector saturation, plume interference, or geometric obstruction.

The beam combiner 232 may be primarily reflective at the process wavelength while permitting a selected partial transmission of process-laser light. The partial transmission may allow a process-return component to reach a detector channel within the OSI system 202. In another configuration, the beam combiner 232 may be primarily transmissive at the process wavelength and reflective at the probe wavelength or may use another reflection and transmission relationship selected according to the source wavelengths, detector arrangement, and desired return-light paths.

The beam combiner 232 may selectively transmit outgoing probe light and incoming returned probe light while reflecting the process beam 230. The beam combiner 232 may additionally transmit light emitted by a laser-material interaction or may direct selected emission wavelengths toward a detector channel. The optical coating of the beam combiner 232 may therefore be selected to support both outgoing beam combination and return-light separation.

The optical reflector component 210 continues to permit the outgoing beam to pass through the pass-through opening 212 while redirecting a broader angular distribution of returned light toward the first and second alternative detector channels,. The optical reflector component 210 may thereby provide spatial separation between the outgoing optical path and at least part of the return-light path without requiring the detector channels to be placed near the workpiece.

The alternative integrated optical architecture may be used with the solid planar or non-planar workpiece described in connection with FIG. 2, the hollow or thin-walled workpiece described in connection with FIG. 3, or the XYZ surface-ablation arrangement described in connection with FIG. 6A. The architecture may also be used with the four-axis grooving and cutting arrangement of FIG. 7 and the layer-by-layer cutting and angular-position arrangements of FIGS. 8A-8C.

When used with a hollow or thin-walled workpiece, the first and second alternative detector channels, may operate together with the transmitted-light detector channel. Returned probe light, process return, plasma emission, and transmitted light may therefore be measured for the same irradiated region. The apparatus control unit 236 may compare the measurements to identify wall modification, hole initiation, breakthrough, remelting, coating change, or another process condition.

When used for surface cleaning or coating removal, one detector channel may monitor returned probe light while another monitors process return or emitted light. The apparatus control unit 236 may use the signals to distinguish removable rust, paint, stain, oxide, or contamination from the underlying substrate. When exposure of the substrate is detected, the apparatus may reduce pulse energy, increase scan speed, omit further pulses, or stop processing at the corresponding region.

When used for grooving, drilling, or cutting, the detector channels may monitor material removal while the feature becomes progressively deeper. Detector measurements may be used to determine whether the process beam remains effectively coupled to the feature bottom, whether a plasma plume is being generated, whether sidewall obstruction is increasing, and whether a through-hole or cut-through endpoint has been reached.

The alternative integrated optical architecture does not require every illustrated detector channel or optical component to be used in every implementation. Detector channels may be selected according to workpiece material, process type, source wavelengths, expected signal strength, and required control function without changing the fundamental arrangement in which outgoing beams are delivered through a common or partially common path and returned light is collected and directed toward stationary detector channels within the OSI system 202.

Referring to FIGS. 10A-10C, a process-laser pulse 1000 provides a timing reference for sampling and analyzing optical diagnostic signals associated with a laser-induced surface-modification process. The process-laser pulse 1000 may represent a single pulse delivered to an irradiated surface region or one pulse within a sequence of pulses delivered to the same or successive regions. The illustrated pulse shape, amplitude, rise time, fall time, and duration are representative and may vary according to the process-laser source 226, the workpiece material, the intended surface modification, and the selected operating parameters.

The apparatus control unit 236 may synchronize operation of the process-laser source 226 with one or more detector channels so that each optical measurement is obtained during a selected temporal portion of the laser-material interaction. The detector channels may include the process-return photodetector 406, probe photodetector 220, plasma-emission photodetector 506, transmitted-light photodetector 308, or another detector configured to measure reflected, scattered, transmitted, polarized, fluorescent, or emitted light. The timing relationships may permit the apparatus to distinguish optical signals produced before irradiation, during energy delivery, during material modification, and after completion of the process-laser pulse 1000.

FIG. 10A illustrates one or more process-return sampling windows 1002 for measuring back-reflected process-laser light from a region irradiated by the process-laser pulse 1000. A first process-return sampling window 1002 may begin shortly after onset of the process-laser pulse 1000, after an initial detector transient or laser turn-on transient has sufficiently subsided. A second process-return sampling window 1002 may occur during a later portion of the process-laser pulse 1000 and before termination of the pulse. Measurements obtained during the respective sampling windows may characterize early and later portions of the process-laser interaction with the workpiece.

The back-reflected process-laser light measured during the process-return sampling windows 1002 may include specularly reflected process light, diffusely scattered process light, or a combination thereof. An early measurement may indicate an initial surface reflectivity, incident-beam coupling, or pre-ablation interaction condition. A later measurement may indicate a change in reflectivity, energy absorption, material removal, plume formation, plasma shielding, feature depth, or geometric obstruction that develops as the process-laser pulse 1000 continues.

The first and second process-return sampling windows 1002 may have the same duration or different durations. Their relative timing may be selected according to the pulse duration, detector bandwidth, signal-conditioning response, expected time of ablation onset, and desired diagnostic information. More than two process-return sampling windows may be used to obtain a time-resolved representation of the process-return signal during the process-laser pulse 1000.

A change between an early process-return measurement and a later process-return measurement may indicate a transition from a sub-threshold condition to effective ablation. In some processing conditions, a decrease in reflected process-laser intensity may indicate increased energy coupling or onset of material removal. A decrease may alternatively result from plasma shielding, debris, an increasing crater or kerf depth, sidewall obstruction, defocus, or another process condition. The apparatus control unit 236 may therefore analyze the process-return measurements alone or together with probe-return, plasma-emission, transmitted-light, position, and process-history data.

FIG. 10B illustrates one or more probe-return sampling windows 1004 for measuring light from the probe beam 208 that is reflected or scattered by the irradiated surface region. A first probe-return sampling window 1004 may occur immediately before the pulse start to establish a pre-process optical condition of the region. This pre-process measurement may provide a baseline representing reflectivity, roughness, coating condition, polarization response, or another optical characteristic before delivery of the process-laser pulse 1000.

A second probe-return sampling window 1004 may occur before the pulse end, during a later portion of the process-laser pulse 1000, to assess the irradiated region during or near completion of the laser-material interaction. The second probe-return measurement may be compared with the pre-process measurement to identify a change caused by the process-laser pulse 1000. The detected change may indicate cleaning, coating removal, remelting, smoothing, ablation, hole formation, modification of surface roughness, or another intended or unintended surface condition.

The probe-return sampling windows 1004 may be selected so that probe illumination is measured when interference from the process beam 230, plasma emission, or detector saturation is sufficiently limited. Wavelength-selective filters, polarization-selective components, temporal gating, background subtraction, or combinations thereof may be used to separate the probe-return signal from other optical components present during the process-laser pulse 1000.

The probe beam 208 may operate continuously, may be modulated independently of the process-laser pulse 1000, or may be pulsed during selected measurement intervals. Where the probe beam 208 is modulated or pulsed, the apparatus control unit 236 may synchronize probe emission with the probe-return sampling windows 1004. A source-monitor measurement or reference detector may be used to normalize the probe-return measurements for variation in probe-source output.

Although FIG. 10B shows a pre-process sampling window and an in-pulse or near-end sampling window, other timing arrangements may be used. A probe-return measurement may additionally or alternatively be obtained immediately after the pulse end, after detector recovery, or after completion of a selected group of process-laser pulses. A post-process probe measurement may provide an inspection result that is less affected by process-laser radiation or plasma emission.

FIG. 10C illustrates a plasma-line sampling window 1006 positioned after the process-laser pulse 1000. The plasma-line sampling window 1006 is configured to measure the intensity of a selected plasma-emission spectral line within light emitted by a laser-induced plasma plume formed during surface ablation. The measured spectral line may be selected according to the material being processed and the diagnostic information desired.

The plasma-line sampling window 1006 may begin after the pulse end and after a selected delay interval 1014. The delay interval 1014 may reduce the contribution of an early continuum-emission phase that can occur during or immediately after the process-laser pulse 1000. Delaying measurement may improve discrimination of a selected discrete spectral line from broadband continuum radiation and may reduce saturation of the plasma-emission photodetector 506.

The duration and position of the plasma-line sampling window 1006 may be selected according to plasma formation, expansion, cooling, and decay characteristics. A relatively early sampling interval may capture stronger emissions but may include more continuum background, while a later interval may provide improved spectral discrimination with reduced signal magnitude. The apparatus control unit 236 may select a compromise between signal strength and spectral selectivity based on workpiece material, pulse energy, detector sensitivity, and the selected emission wavelength.

A plasma-line measurement may indicate whether material ablation occurred and may provide information concerning the relative intensity or stability of the laser-material interaction. A weak or absent selected spectral line may indicate insufficient fluence, lack of material removal, misalignment, or another process condition. An unexpectedly strong or prolonged signal may indicate excessive energy delivery, a larger-than-intended plasma plume, or another condition requiring adjustment of process parameters.

For a single-crystal diamond example, the selected plasma-emission spectral line may be near approximately 427 nm. The illustrated wavelength is representative of one disclosed material and does not limit the apparatus to that wavelength. Other workpiece materials may produce useful diagnostic spectral lines at different wavelengths and may require different delay intervals 1014, sampling integration intervals, optical filters, and detector sensitivities.

Referring collectively to FIGS. 10A-10C, a time axis represents relative timing among the process-laser pulse 1000, process-return sampling windows 1002, probe-return sampling windows 1004, and plasma-line sampling window 1006. The illustrated temporal positions, widths, and spacing of the pulse and sampling windows are representative and may be adjusted according to source timing, detector response, signal-conditioning characteristics, workpiece material, and the laser-induced process being monitored.

A pulse start identifies the beginning of the process-laser pulse 1000, and a pulse end identifies the end of the process-laser pulse 1000. The pulse start and pulse end may be determined from a command signal supplied to the process-laser source 226, an electrical trigger, an optical pulse monitor, a source-status signal, or another timing reference. Where the actual optical pulse is delayed relative to an electrical trigger, the apparatus control unit 236 may compensate for that delay.

The process-laser pulse 1000 need not have an ideal rectangular profile. The pulse may have finite rise and fall times, a Gaussian temporal profile, a shaped temporal profile, multiple sub-pulses, or another waveform. The pulse start and pulse end may correspond to threshold crossings, commanded times, measured optical times, or another defined temporal boundary used for synchronization.

The delay interval 1014 may separate the pulse end from the beginning of the plasma-line sampling window 1006. The delay interval 1014 may be selected to improve spectral-line discrimination, avoid detector saturation, permit decay of continuum emission, or target a particular stage of plasma evolution. The delay interval 1014 may be fixed for a process recipe or adjusted according to pulse energy, workpiece material, measured plasma behavior, or another process parameter.

A sampling integration interval defines a period during which detector output is accumulated, averaged, digitized, or otherwise processed. The sampling integration interval may correspond to the full width of a sampling window or to a selected portion thereof. The integration interval may be fixed or variable and may be selected according to signal magnitude, detector bandwidth, repetition rate, expected background, and desired signal-to-noise ratio.

A shorter sampling integration interval may provide improved temporal resolution but may collect less optical energy. A longer sampling integration interval may improve signal-to-noise ratio but may average changes occurring during the interval. The apparatus control unit 236 may adjust the sampling integration interval dynamically based on measured signal strength, detector saturation, or the processing stage.

The process-return sampling windows 1002 may be selected to avoid an electrical or optical transient at the pulse start and to obtain a useful measurement before the pulse end. The first process-return sampling window may characterize the surface shortly after energy delivery begins, while the later process-return sampling window may characterize the surface after heating, melting, ablation, plume formation, or geometric change has progressed.

The apparatus control unit 236 may calculate a difference, ratio, temporal slope, normalized change, or other relationship between the early and late process-return measurements. A decrease or increase beyond a selected threshold may be used to identify onset of ablation, changing beam coupling, plasma shielding, feature-depth effects, or another processing condition. The resulting determination may be used to adjust the current pulse when real-time control is available or to adjust to a subsequent pulse or region.

The pre-process and later probe-return measurements may likewise be compared to determine a surface change associated with the process-laser pulse 1000. The comparison may be normalized to probe-source power, a reference region, a calibration measurement, or a preceding measurement. The apparatus control unit 236 may determine whether the intended modification was achieved and may re-irradiate the region or adjust processing of a later region when the measured change falls outside an acceptable range.

In another operating sequence supported by the common-path architecture, an additional post-process probe measurement may be obtained after the pulse end or after a selected plurality of process-laser pulses. The post-process measurement may be used with, or instead of, an in-pulse probe measurement when detector recovery, source timing, process-laser interference, plasma decay, or the inspection objective favors temporal separation from the process pulse.

A post-process probe measurement may occur after a fixed delay or after a measured optical condition indicates that plasma or emitted-light intensity has sufficiently decreased. The resulting measurement may characterize reflectivity, roughness, coating removal, remelting, surface quality, or another condition after the irradiated region has partially or substantially stabilized.

The apparatus control unit 236 may generate timing signals for the process-laser source 226 and the detector channels and may compensate for optical-path delay, detector latency, detector rise and fall time, signal-conditioning delay, filter delay, analog-to-digital conversion timing, and communication latency. Timing corrections may be stored as calibration values associated with a particular source, detector channel, or optical configuration.

Synchronization may be referenced to a laser trigger, measured optical pulse, scanner position, stage position, encoder signal, pulse index, or another timing or position signal. Where the beam is scanned or the workpiece is moved continuously, detector sampling may also be gated according to the position of the process focal spot and probe focal spot so that each measurement is associated with a defined irradiated surface region.

When multiple process-laser pulses 1000 are delivered to the same region, diagnostic sampling may occur during every pulse, during selected pulses, after a selected number of pulses, or after completion of a pulse group. Measurements from multiple pulses may be averaged to improve signal-to-noise ratio, compared to identify a progressive change, or used individually to detect an endpoint.

The apparatus control unit 236 may terminate additional pulses when one or more detector signals indicate that an intended modification has been achieved. For example, a change in transmitted light may indicate breakthrough of a thin wall, a change in process return may indicate a cutting endpoint or geometric obstruction, and a plasma-line measurement may indicate whether effective ablation continues. The apparatus may also reduce energy or modify focal position when the signals indicate excessive processing.

When successive pulses are delivered to different workpiece regions, the detector measurements may be associated with the corresponding coordinates, workpiece orientation, pulse number, scan position, and processing parameters. The measurements may be stored as a one-dimensional profile, two-dimensional image, three-dimensional map, or other spatially indexed process record.

The timing relationships may be adjusted according to the workpiece material and intended process. Ablation of diamond, silicon, silicon carbide, polymer, metal, ceramic, coating material, or another workpiece may produce different return-signal behavior and plasma-emission timing. Different processes, including cleaning, coating removal, drilling, grooving, cutting, remelting, smoothing, and patterning, may therefore use different sampling-window positions and durations.

The timing diagrams do not require a particular process-pulse duration, pulse repetition rate, absolute time scale, or detector-sampling frequency. The same relative timing concepts may be applied to nanosecond, picosecond, femtosecond, microsecond, millisecond, or other pulse regimes where compatible with the disclosed laser-material process and detector response.

The signal analyzer 238 may compare measurements obtained during the process-return sampling windows 1002, probe-return sampling windows 1004, and plasma-line sampling window 1006. The measurements may be evaluated individually or combined using thresholds, ratios, differences, temporal derivatives, normalized values, weighted combinations, or another analysis appropriate for the process.

Combined temporal measurements may improve discrimination among insufficient fluence, effective ablation, excessive plume shielding, changing material reflectivity, geometric obstruction by a deep crater or kerf, defocus, coating breakthrough, wall perforation, and completion of a drilling or cutting operation. For example, low process return together with strong plasma emission may indicate active ablation, while low process return together with weak plasma emission may indicate geometric blockage, defocus, or insufficient energy reaching the material.

The apparatus control unit 236 may use the combined analysis to adjust pulse energy, pulse duration, repetition rate, pulse count, scan speed, focal position, workpiece position, roll angle, layer increment, assist-gas operation, or another process parameter. The adjustment may be applied to the same irradiated region when real-time or near-real-time control is available, to a subsequent pulse delivered to the region, to a later layer, or to a later workpiece region.

The timing arrangements of FIGS. 10A-10C may be used separately or in combination. A particular implementation may use only process-return sampling, only probe-return sampling, only plasma-line sampling, or any technically compatible combination of those measurements. Additional sampling windows may be provided for transmitted light, polarization-dependent light, fluorescence, source monitoring, background measurement, or another optical signal without changing the disclosed synchronization principles.

The embodiments described in FIGS. 1-10C may be combined in any technically compatible manner according to the workpiece, laser process, inspection objective, and required positioning capability. Referring to FIGS. 1-10C, a solid workpiece, hollow workpiece, thin-walled article, coating, membrane, slab, or other object may be processed using the multi-axis positioning system 260, XYZ positioning system 600, four-axis positioning system 700, beam-scanning system 100, or a coordinated combination of those arrangements. Returned-light separation may be provided within the COA 250, within the OSI system 202, or at multiple locations along the return optical path. One or more probe-return, process-return, transmitted-light, plasma-emission, fluorescence, polarization-sensitive, or other optical detector channels may be selected according to the diagnostic information required for a particular process.

A particular implementation need not reproduce the exact physical arrangement illustrated for any one embodiment. Components described in connection with one embodiment may be incorporated into another embodiment when their functions are compatible. For example, the transmitted-light detector channel described for a hollow or thin-walled workpiece may be used with an XYZ or four-axis positioning arrangement. Likewise, the wavelength-selective, spatially selective, or annular return-light separation components may be used with a solid workpiece, a hollow workpiece, a cleaning process, a grooving process, or a cutting process.

Relative positioning between the process focal spot, probe focal spot, and workpiece may be provided by moving the workpiece, moving the COA 250, scanning one or both optical beams, or coordinating multiple positioning mechanisms. A movable workpiece may be processed by substantially stationary optical components, while a stationary or difficult-to-move workpiece may be processed by moving the COA 250. In another arrangement, beam scanning provides rapid local X-Y positioning while one or more translation or rotation stages provide larger-scale motion, focus correction, or angular adjustment.

The COA 250 may be mounted to a robotic manipulator, articulated arm, gantry, translation stage, mobile platform, vehicle, or another positioning mechanism capable of moving the optical assembly relative to a workpiece. Such an arrangement may be useful for large structures, curved surfaces, marine objects, industrial equipment, pipes, tanks, panels, or other workpieces that cannot conveniently be mounted on a conventional stage. The robotic or mobile positioning mechanism may provide translational and rotational motion sufficient to maintain focal position, working distance, beam incidence, and detector collection geometry as the COA 250 follows the workpiece surface.

Optical fibers or other beam-delivery media may transport the process beam 230 and probe beam 208 from substantially stationary source assemblies to a movable COA 250 when compatible with the source wavelength, optical power, pulse energy, pulse duration, polarization, and beam-quality requirements. Separate fibers may transport the process and probe beams, or the beams may be combined before entering a common delivery medium. Returned light may be transported through the same or a separate optical medium to one or more stationary detector channels.

The apparatus control unit 236 may coordinate laser operation, beam scanning, stage movement, robotic movement, detector sampling, assist-gas delivery, extraction operation, and storage of process data. The apparatus control unit 236 may receive commanded positions, encoder signals, surface-model information, detector signals, source-monitor signals, and process-status information and may associate each measurement with a corresponding workpiece position, orientation, pulse number, processing layer, and operating condition.

The apparatus may construct a one-dimensional profile, two-dimensional image, three-dimensional map, or other spatially indexed representation of a processed or inspected surface. Each pixel or data record may correspond to a defined workpiece region and may store one or more optical measurements together with position, orientation, time, process parameters, pulse information, layer information, and a determination regarding whether an intended modification was achieved. Different detector measurements may be stored as separate channels or may be combined into a composite process or inspection value.

The image, map, or other stored representation may be used during processing or after completion of an initial processing pass. A region that does not satisfy a predetermined value, range, threshold, comparison, or expected result may be re-irradiated. Processing parameters applied to a subsequent region or subsequent material layer may be adjusted based on measurements obtained from an earlier region. The stored data may also be used to identify regions for later rework, verify process coverage, document process results, or compare a completed workpiece with a reference condition.

Process control may include adjustment of pulse energy, pulse duration, pulse shape, repetition rate, number of pulses, focal position, focal-spot geometry, beam intensity distribution, scan speed, pulse spacing, focal-spot overlap, workpiece position, workpiece orientation, angle of incidence, layer increment, assist-gas pressure or flow, extraction operation, detector gain, sampling delay, integration interval, or another operating parameter. A control decision may be based on a single detector signal or on a combined analysis of multiple signals.

A combined analysis may use an absolute intensity, normalized intensity, difference, ratio, temporal change, rate of change, integrated value, threshold crossing, spectral-line intensity, polarization change, or another derived quantity. For example, process return and plasma emission may be compared to distinguishing insufficient delivered fluence from excessive plasma shielding or geometric obstruction. Probe return and transmitted light may be compared to distinguish a change in surface reflectivity from completion of a through-hole. Multiple measurements may also be compared with source-monitor data, a calibration value, a reference region, or a preceding measurement.

The disclosed applications include laser micro-drilling of intravenous drug-delivery balloons, catheter balloons, tubes, membranes, and other thin-walled medical or technical articles. The workpiece may be positioned so that the process focal spot remains at a selected location on a curved or compliant wall while transmitted light, probe return, process return, or plasma emission is monitored. A change in one or more detector signals may identify hole initiation, increasing penetration, wall breakthrough, or completion of a through-hole. The apparatus control unit 236 may terminate or modify irradiation when the intended hole has been formed to reduce unnecessary damage to surrounding material.

The disclosed apparatus may also remelt, iron, smooth, polymerize, or otherwise treat a surface layer of a three-dimensional printed polymer object, polymer coating, thin-walled polymer article, or other polymer-containing workpiece. Controlled remelting or smoothing may reduce surface roughness, reduce or reshape surface features, improve appearance, modify optical properties, or improve surface and structural characteristics. Probe-return, transmitted-light, polarization-sensitive, or other optical measurements may be used to limit overheating, excessive thinning, deformation, or unintended perforation.

Polymerization or other light-induced treatment may be performed on a surface material, coating, resin, adhesive, composite matrix, or other reactive material. The process beam 230 may deliver energy sufficient to initiate or continue a desired chemical or physical change, while the probe beam 208 and detector channels monitor the resulting modification. Measurements may be used to determine whether a selected treatment level has been achieved or whether additional irradiation is required.

The disclosed applications further include laser cleaning of rust, stain, paint, oxide, contamination, residue, and other coatings or surface materials from marine, shipbuilding, structural, transportation, energy, manufacturing, or industrial objects. The object may include planar, cylindrical, curved, faceted, or free-form surface regions. A mobile or robot-mounted COA 250 may follow the surface while maintaining focal position and angle of incidence.

During cleaning or coating removal, optical feedback may distinguish the removable material from the underlying substrate. Probe return, process return, plasma emission, polarization response, or another measured optical characteristic may change when the underlying substrate becomes exposed. In response, the apparatus control unit 236 may reduce pulse energy, increase scan speed, decrease pulse overlap, omit further irradiation, or stop processing at the corresponding region. Closed-loop control may reduce damage to the underlying material while improving cleaning coverage and repeatability.

The cleaning arrangement may include the assist-gas assembly and extraction system. Assist gas may displace particles, vapor, smoke, coating fragments, and other process by-products from the irradiated region, while extraction may collect and remove those materials from the work area. The assist-gas nozzle and extraction conduit 814 may be carried with the COA 250 or mounted on separate positioning mechanisms that follow the processing region.

Semiconductor applications include formation of narrow grooves or trenches, blind holes, through-holes, surface patterns, alignment features, recesses, cutting paths, and separated articles in silicon, silicon carbide, another semiconductor, a semiconductor coating, or a semiconductor-containing structure. Material may be removed region by region and layer by layer while detector measurements monitor delivered energy, material removal, plasma formation, feature depth, sidewall condition, or process endpoint.

A semiconductor slab, block, or wafer may be cut by repeatedly deepening a groove or cutting kerf 712 until complete separation occurs. The Z-axis position may be adjusted as the kerf bottom advances, and the roll angle may be changed to reduce beam blockage by the kerf sidewalls,. Reducing the width of the groove or cutting kerf 712 may reduce material loss and increase the number of usable wafers or components produced from a block or slab.

The apparatus may also create shallow or deep trenches without completely separating the semiconductor workpiece. Such trenches may have selected width, depth, sidewall angle, bottom profile, or width-to-depth aspect ratio. Detector feedback may identify incomplete material removal, sidewall obstruction, excessive plume shielding, defocus, or another condition and may cause the apparatus control unit 236 to adjust pulse energy, scan speed, focal position, roll angle, or layer increment.

Diamond applications include surface texturing, micro-patterning, drilling, grooving, and cutting a single-crystal or polycrystalline diamond workpiece. A single-crystal diamond slab may be divided into thinner wafers or other articles through repeated layer-by-layer ablation. Because diamond material may be comparatively valuable, reduction of cutting-kerf width and improved dimensional consistency may increase usable material yield.

Angular adjustment during diamond cutting may improve process-energy coupling at the kerf bottom, reduce obstruction by the kerf sidewalls,, improve kerf-width uniformity, and improve sidewall straightness or kerf-wall quality. Process-return and plasma-emission measurements may provide in-situ information regarding ablation activity, beam coupling, plume shielding, and feature geometry. A selected plasma-emission spectral line, including a line near approximately 427 nm in one diamond-processing example, may be measured after a selected delay following a process pulse.

The apparatus may similarly process glass, ceramic, metal, composite, coating, polymer, semiconductor, diamond, or another material compatible with the selected process-laser wavelength and operating conditions. Representative operations include cleaning, coating removal, texturing, patterning, structuring, drilling, grooving, cutting, remelting, smoothing, heat treatment, polymerization, and localized modification of an optical, mechanical, physical, chemical, or structural property.

The disclosed systems may process planar or non-planar surfaces, rigid or compliant walls, coatings, membranes, shells, tubes, balloons, slabs, panels, blocks, and other objects. A single workpiece may include both planar and curved regions, regions having different thicknesses, coated and uncoated regions, or regions having different local orientations. Relative positioning may be adapted region by region to maintain focal position, angle of incidence, beam overlap, working distance, and detector collection geometry.

A hollow or thin-walled workpiece may be inspected using a transmitted-light detector positioned behind, beneath, within, or on an opposite side of the wall. A solid workpiece may be inspected using returned probe light, process-laser return, plasma emission, fluorescence, polarization response, or another collected optical signal. The same apparatus may use different detector channels for different portions of a workpiece or different stages of a processing operation.

The disclosed optical arrangements may be configured so that the process beam 230 and probe beam 208 are substantially collinear, partially overlapping, laterally offset, or angularly offset. The probe focal spot may lead the process focal spot to obtain a pre-process measurement, may substantially overlap the process focal spot, or may trail the process focal spot to obtain a post-process measurement. The selected relationship may remain fixed or may be changed during processing.

A particular implementation may employ only a process beam, only a probe beam during selected inspection intervals, or both beams concurrently or sequentially. The process beam itself may function as a diagnostic probe when back-reflected process-laser light provides useful information. Light emitted by the laser-material interaction may provide a further diagnostic signal without requiring a separate probe wavelength.

The assist-gas assembly and extraction system may be used with grooving, cutting, drilling, cleaning, coating removal, or another material-modification process. Gas composition, pressure, flow rate, nozzle position, and extraction rate may be selected according to material, feature geometry, desired chemical environment, debris characteristics, and optical-measurement requirements. Assist gas and extraction may be used together or independently and need not be synchronized with individual process-laser pulses.

Processing may begin directly on a smooth, rough, coated, uncoated, polished, unfinished, or otherwise untreated workpiece surface without requiring a preliminary surface-conditioning pass. An optional cleaning, alignment, focus-verification, baseline-measurement, or calibration operation may nevertheless be performed when independently desired. The absence of a required conditioning operation permits the apparatus to begin the intended modification directly at a selected workpiece region.

The foregoing alternatives provide written-description and implementation support for combinations consistent with the disclosed optical, mechanical, positioning, detection, timing, and control architectures. A particular implementation need not include every detector channel, positioning axis, optical component, beam-shaping component, assist-gas component, extraction component, timing window, or control function described herein. Components and functions may be omitted, duplicated, relocated, or combined when technically compatible with the intended process.

The terminology used to describe a particular component is not intended to require a single physical construction. For example, an optical filter may comprise one optical element or multiple optical elements; a detector channel may include a detector, filter, aperture, condensing optic, signal conditioner, and associated electronics; and a positioning system may distribute translational and rotational axes among the workpiece, COA 250, scanner, robotic assembly, or other mechanisms. The disclosed functionality may therefore be implemented through different physical arrangements while preserving the described relationships among beam delivery, workpiece positioning, optical inspection, signal analysis, and process control.

What is claimed is:

1. An apparatus for in-situ optical inspection and control of laser-induced modification of a workpiece, comprising:
a process-laser system comprising a process-laser source configured to generate a process beam for modifying at least one optical, mechanical, physical, chemical, or structural property of an irradiated region of the workpiece;
an optical surface inspection system comprising a probe source configured to generate a probe beam, an optical reflector component comprising a pass-through opening and a reflective surface surrounding at least a portion of the pass-through opening and a probe photodetector configured to generate a probe detector signal;
a beam combiner configured to combine the process beam and the probe beam along at least a portion of a common optical path;
a control optics assembly comprising focusing optics configured to focus the process beam and the probe beam at the irradiated region and to collect returned or emitted light from the irradiated region; and
an apparatus control unit configured to analyze the probe detector signal and control at least one operating parameter of the process-laser system based on the probe detector signal, wherein the probe beam passes through the pass-through opening toward the beam combiner, at least part of the returned or emitted light propagates from the irradiated region through at least a portion of the common optical path, and the reflective surface redirects at least a portion of the returned or emitted light toward the probe photodetector.

2. The apparatus of claim 1, wherein the apparatus control unit is configured to obtain a first probe detector measurement before a process-laser pulse and a second probe detector measurement during or after the process-laser pulse and to control a subsequent process-laser pulse based on a comparison of the first and second probe detector measurements.

3. The apparatus of claim 1, further comprising at least one additional detector channel configured to measure back-reflected process-laser light, transmitted light, polarization-dependent light, fluorescence, or a selected spectral component of light emitted by a laser-induced plasma plume.

4. The apparatus of claim 1, wherein the optical reflector component comprises a flat reflector, a curved reflector, an apertured dichroic reflector, or a prism-shaped reflector having the pass-through opening and the reflective surface.

5. The apparatus of claim 1, further comprising beam-shaping optics configured to produce the process beam with a flat-top, Gaussian, super-Gaussian, multimode, Bessel, Airy, or annular intensity profile and with a circular, elliptical, square, rectangular, elongated, or line-shaped focal spot.

6. The apparatus of claim 1, wherein a process focal spot of the process beam and a probe focal spot of the probe beam are spatially separated, and wherein the probe focal spot leads the process focal spot for pre-process inspection or trails the process focal spot for post-process inspection as the focal spots move over the workpiece.

7. The apparatus of claim 1, wherein the apparatus control unit is configured to associate detector measurements with corresponding workpiece positions to construct a spatially indexed profile, image, or three-dimensional map and to re-irradiate a region or modify processing of another region based on the profile, image, or three-dimensional map.

8. An apparatus for in-situ optical inspection and control of laser-induced modification of a workpiece, comprising:
a process-laser system comprising a process-laser source configured to generate a process beam for modifying at least one optical, mechanical, physical, chemical, or structural property of an irradiated region of the workpiece;
an optical surface inspection system comprising a probe source configured to generate a probe beam, an optical reflector component comprising a pass-through opening and a reflective surface surrounding at least a portion of the pass-through opening and a probe photodetector configured to generate a probe detector signal;
a beam combiner configured to combine the process beam and the probe beam along at least a portion of a common optical path;
a control optics assembly comprising focusing optics configured to focus the process beam and the probe beam at the irradiated region and to collect returned or emitted light from the irradiated region;
an apparatus control unit configured to analyze the probe detector signal and control at least one operating parameter of the process-laser system based on the probe detector signal, wherein the probe beam passes through the pass-through opening toward the beam combiner, at least part of the returned or emitted light propagates from the irradiated region through at least a portion of the common optical path, and the reflective surface redirects at least a portion of the returned or emitted light toward the probe photodetector; and
a multi-axis positioning system configured to provide relative translational and rotational movement between the control optics assembly and the workpiece to maintain a focal position and a selected angle of incidence at successive irradiated regions of a planar or non-planar surface of the workpiece.

9. The apparatus of claim 8, wherein the multi-axis positioning system comprises a linear stage assembly providing X-, Y-, and Z-axis movement and a rotational stage assembly providing pitch, roll, and yaw movement.

10. The apparatus of claim 8, wherein the workpiece comprises a hollow or thin-walled workpiece, and further comprising a transmitted-light detector positioned to receive light passing through a wall of the workpiece and to generate a transmitted-light detector signal used by the apparatus control unit to detect wall modification, hole initiation, or breakthrough.

11. The apparatus of claim 8, further comprising a wavelength-selective return mirror positioned in a return-light path, a beam blocker positioned to attenuate or block a spatially concentrated specular component of the returned or emitted light while transmitting an off-axis scattered or emitted component and a detector aperture configured to limit a field of view of a detector receiving the off-axis scattered or emitted component.

12. The apparatus of claim 8, further comprising an annular beam-separation component having a central pass-through opening through which a substantially axial specular return passes and an annular region configured to redirect or block a broader angular distribution of returned or emitted light toward a detector.

13. The apparatus of claim 8, wherein the optical surface inspection system comprises first, and second stationary detector channels configured to measure different wavelength, polarization, angular, or temporal components of the returned or emitted light collected by the control optics assembly.

14. The apparatus of claim 8, wherein the control optics assembly is mounted to a robotic manipulator, articulated arm, gantry, or mobile platform, and wherein at least one optical fiber transports the process beam or the probe beam from a stationary source assembly to the movable control optics assembly.

15. An apparatus for in-situ optical inspection and control of laser-induced modification of a workpiece, comprising:
a process-laser system comprising a process-laser source configured to generate a process beam for modifying at least one optical, mechanical, physical, chemical, or structural property of an irradiated region of the workpiece;
an optical surface inspection system comprising a probe source configured to generate a probe beam, an optical reflector component comprising a pass-through opening and a reflective surface surrounding at least a portion of the pass-through opening and a probe photodetector configured to generate a probe detector signal;
a beam combiner configured to combine the process beam and the probe beam along at least a portion of a common optical path;
a control optics assembly comprising focusing optics configured to focus the process beam and the probe beam at the irradiated region and to collect returned or emitted light from the irradiated region;
an apparatus control unit configured to analyze the probe detector signal and control at least one operating parameter of the process-laser system based on the probe detector signal, wherein the probe beam passes through the pass-through opening toward the beam combiner, at least part of the returned or emitted light propagates from the irradiated region through at least a portion of the common optical path, and the reflective surface redirects at least a portion of the returned or emitted light toward the probe photodetector; and
a four-axis positioning system comprising an X-axis stage, a Y-axis stage, a Z-axis stage, and a roll stage configured to position the workpiece during formation of a groove or cutting kerf and to vary an angle of the workpiece relative to the process beam as the groove or cutting kerf is formed.

16. The apparatus of claim 15, wherein the apparatus control unit is configured to remove material region by region and layer by layer and to adjust the Z-axis stage after removal of one or more material layers to maintain a process focal spot at or near a bottom of the groove or cutting kerf.

17. The apparatus of claim 15, wherein the apparatus control unit is configured to determine an angular position of the roll stage based on a depth of the groove or cutting kerf and a lateral position of a process focal spot between opposing sidewalls of the groove or cutting kerf, and further wherein the beam angular adjustment is achieved by adjusting the angle of a incident laser beam by laterally moving a focusing lens under the normal incident beam.

18. The apparatus of claim 15, wherein the apparatus control unit is configured to position the workpiece in a neutral angular position while removing material from a central portion of the groove or cutting kerf, in a first angular position while removing material adjacent to a first kerf sidewall and in a second angular position opposite the first angular position while removing material adjacent to a second kerf sidewall, and wherein the angular position is adjusted between the central neutral adjustment and sidewalls adjustment values as desired to minimize the interference between the incident beam and the kerf opening and walls.

19. The apparatus of claim 15, further comprising an assist-gas assembly comprising a pressurized gas source and a nozzle configured to direct a gas stream toward the groove or cutting kerf and an extraction system comprising an extraction conduit configured to evacuate particles, molten material, vapor, plasma, or other process by-products from the groove or cutting kerf.

20. The apparatus of claim 15, wherein the workpiece comprises a silicon, silicon-carbide, or diamond slab, and wherein the apparatus control unit is configured to cut a slab piece into thin wafers, and wherein identify a cut-through endpoint based on commanded depth, transmitted light, process return, probe return, plasma emission, or mechanical separation and to terminate or reduce laser processing in response to identification of the cut-through endpoint.
